(19) United States
(12) Patent Application Publication
(10) Pub. No.: US 2026/0354296 A1
(43) Pub. Date: Nov. 12, 2026

(54) INFORMATION PROCESSING APPARATUS, INFORMATION PROCESSING METHOD, AND PROGRAM

(71) Applicant: Sony Group Corporation, Tokyo (JP)

(72) Inventors: Godai Suzuki, Kanagawa (JP); Masatoshi Funabashi, Tokyo (JP)

(73) Assignee: Sony Group Corporation, Tokyo (JP)

(21) Appl. No.: 19/139,831

(22) PCT Filed: Dec. 5, 2023
(86) PCT No.: PCT/JP2023/043395

§ 371 Date: Jun. 16, 2025

(30) Foreign Application Priority Data
Dec. 23, 2022 (JP) 2022-206609

(51) Int. Cl. A01B 79/00

(52) U.S. Cl. CPC A01B 79/005

(57) ABSTRACT

The present technology relates to an information processing apparatus, an information processing method, and a program that enable proposal of a work appropriate for construction of an extended ecosystem.

By using state information regarding a state of an ecosystem including biological diversity of the ecosystem, the state of the ecosystem after a work in a case where a work indicated by work information including a type of the work by a work device and a work parameter is performed on the ecosystem is predicted. A prediction state that is the predicted state of the ecosystem is evaluated, and proposal work information that is the work information to be proposed is determined according to an evaluation result. The present technology can be applied to, for example, an ecosystem support system that supports construction of an extended ecosystem, and the like.

### TECHNICAL FIELD

The present technology relates to an information processing apparatus, an information processing method, and a program, and particularly relates to, for example, an information processing apparatus, an information processing method, and a program that enable proposal of a work appropriate for construction of an extended ecosystem.

### BACKGROUND ART

As a technology of smart agriculture, there is a technology of optimizing protocol of a farming method according to a difference in soil or climate of a place of practice. In such a technology, as a harvesting result such as a yield amount and quality of harvested products, parameters of a farming work such as a planting plan and an amount of applied fertilizer are optimized so that a desired result can be obtained (see, for example, Patent Documents 1 and 2).

### CITATION LIST

### Patent Document

Patent Document 1: Japanese Patent Application Laid-Open No. 2020-149652

Patent Document 2: Japanese Patent Application Laid-Open No. 2019-175246

### SUMMARY OF THE INVENTION

### Problems to be Solved by the Invention

In recent years, Synecoculture (registered trademark) of producing useful plants in an ecologically optimized state on the basis of thinning harvesting from mixed dense planting while achieving biodiversity exceeding a natural state through vegetation arrangement under restrictions of no till, no fertilizer, and no pesticides, with only seeds and seedlings introduced has attracted attention. Under Synecoculture (registered trademark), an extended ecosystem with enhanced biodiversity and ecosystem function can be constructed.

The above-described technology of smart agriculture is intended for management of conventional agriculture, and thus, it is difficult to apply the technology to management of Synecoculture (registered trademark).

There is therefore demand for a technology applicable to management of Synecoculture (registered trademark), for example, a technology for proposing a work appropriate for construction of an extended ecosystem.

The present technology has been made in view of such a situation, and is intended to propose a work appropriate for construction of an extended ecosystem.

### Solutions to Problems

An information processing apparatus or a program of the present technology is an information processing apparatus including: a prediction unit that predicts a state of an ecosystem after a work in a case where a work indicated by work information including a type of the work by a work device and a work parameter is performed on the ecosystem by using state information regarding a state of the ecosystem including biological diversity of the ecosystem; an evaluation unit that evaluates a prediction state that is the predicted state of the ecosystem; and a determination unit that determines proposal work information that is the work information to be proposed according to an evaluation result of the prediction state, or a program for causing a computer to function as such an information processing apparatus.

An information processing method of the present technology is an information processing method including: predicting a state of an ecosystem after a work in a case where a work indicated by work information including a type of the work by a work device and a work parameter is performed on the ecosystem by using state information regarding a state of the ecosystem including biological diversity of the ecosystem; evaluating a prediction state that is the predicted state of the ecosystem; and determining proposal work information that is the work information to be proposed according to an evaluation result of the prediction state.

In the information processing apparatus, the information processing method, and the program of the present technology, the state of the ecosystem after the work in a case where the work indicated by the work information including the type of the work by the work device and the work parameter is performed on the ecosystem is predicted using the state information regarding the state of the ecosystem including the biological diversity of the ecosystem, and the prediction state that is the predicted state of the ecosystem is evaluated. Then, the proposal work information that is the work information to be proposed is determined according to the evaluation result of the prediction state.

The information processing apparatus may be an independent apparatus or an internal block constituting one apparatus.

Further, the program may be provided by being transmitted through a transmission medium or being recorded in a recording medium.

### BRIEF DESCRIPTION OF DRAWINGS

FIG. 1 is a view illustrating a configuration example of an embodiment of an information processing system to which the present technology is applied.

FIG. 2 is a view illustrating a hardware configuration example of a terminal 11.

FIG. 3 is a view illustrating a hardware configuration example of a server 12.

FIG. 4 is a view for explaining outline of processing of an information processing system 10.

FIG. 5 is a view for explaining a data set stored in a DB 13.

FIG. 6 is a view illustrating an example of a work device 22.

FIG. 7 is a view illustrating another example of the work device 22.

FIG. 8 is a block diagram illustrating a first functional configuration example of the server 12.

FIG. 9 is a view for explaining a DB space.

FIG. 10 is a view for explaining a first example of determination of proposal work information and assignment of the proposal work information to sub-areas.

FIG. 11 is a view for explaining a second example of determination of proposal work information and assignment of the proposal work information to sub-areas.

FIG. 12 is a view for explaining a third example of determination of proposal work information and assignment of the proposal work information to sub-areas.

FIG. 13 is a view for explaining a fourth example of determination of proposal work information and assignment of the proposal work information to sub-areas.

FIG. 14 is a flowchart for explaining an example of processing of the server 12 storing information in the DB 13.

FIG. 15 is a flowchart for explaining an example of processing of the server 12 proposing a work to be performed on an ecosystem.

FIG. 16 is a view illustrating an example of state information and work information.

FIG. 17 is a block diagram illustrating a second functional configuration example of the server 12.

FIG. 18 is a view illustrating an example of restriction information.

FIG. 19 is a view illustrating an example of current state information and candidate work information.

FIG. 20 is a block diagram illustrating a second functional configuration example of the server 12.

FIG. 21 is a view illustrating an example of evaluation values and prediction accuracy obtained for the candidate work information.

FIG. 22 is a block diagram illustrating a fourth functional configuration example of the server 12.

FIG. 23 is a block diagram illustrating a fifth functional configuration example of the server 12.

FIG. 24 is a view illustrating a first display example of a presentation UI.

FIG. 25 is a view for explaining an example of editing of a work table.

FIG. 26 is a view illustrating a second display example of the presentation UI.

FIG. 27 is a view illustrating a third display example of the presentation UI.

FIG. 28 is a view illustrating a fourth display example of the presentation UI.

FIG. 29 is a view for explaining a relationship between the number of arranged work devices 22 and a work parameter that can be set in generation of the candidate work information.

FIG. 30 is a view for explaining an example of determination of extension work information in a case where a range of a work that can be performed by the entire work devices 22 partially overlaps in a plurality of different areas.

FIG. 31 is a view for explaining another example of determination of the extension work information in a case where the range of the work that can be performed by the entire work devices 22 partially overlaps in a plurality of different areas.

FIG. 32 is a view for further explaining still another example of determination of the extension work information in a case where the range of work that can be performed by the entire work devices 22 partially overlaps in a plurality of different areas.

### MODE FOR CARRYING OUT THE INVENTION

### Embodiment of Information Processing System to which Present Technology is Applied

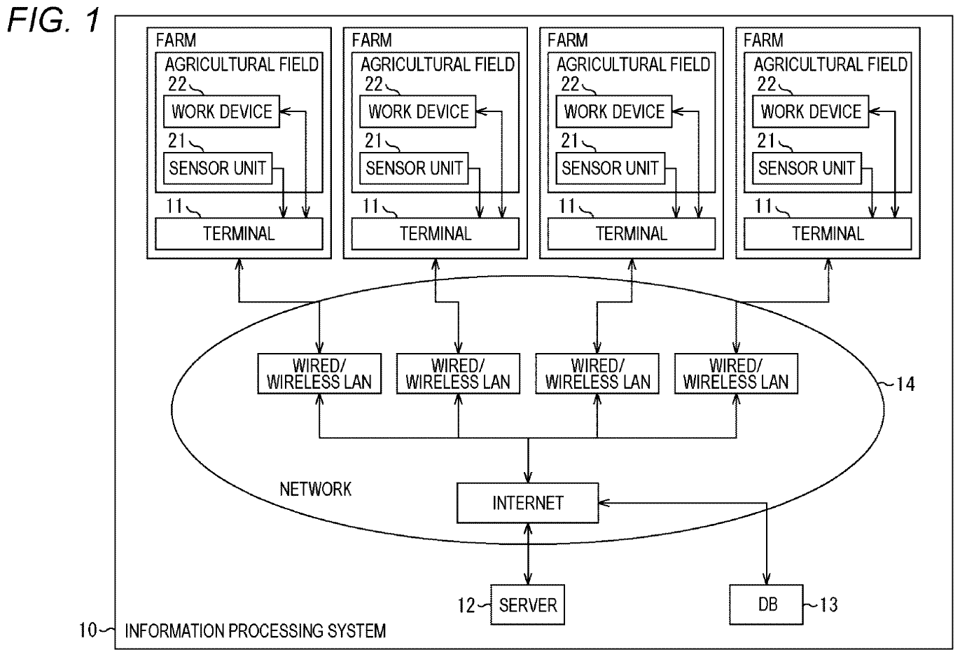

FIG. 1 is a view illustrating a configuration example of an embodiment of an information processing system to which the present technology is applied.

An information processing system 10 constitutes an ecosystem support system that supports construction of a target extended ecosystem by proposing a work appropriate for construction of the target extended ecosystem.

The information processing system 10 includes one or more terminals 11-i, one or more servers 12, and a database (DB) 13. The terminal 11-i, the server 12, and the DB 13 can communicate with each other via a network 14 including a wired local area network (LAN), a wireless LAN, the Internet, a mobile communication network such as 5G, and the like.

In FIG. 1, four terminals 11-1, 11-2, 11-3, and 11-4 are provided as the terminals 11-i, but the number of terminals 11-i may be 1 to 3, or 5 or more. Hereinafter, the terminals 11-1, 11-2, 11-3, and 11-4 will be referred to as the terminal 11 unless otherwise distinguished.

Furthermore, in FIG. 1, one server 12 is provided as the server 12, but a plurality of servers 12 may be provided. In a case where a plurality of servers 12 is provided, the plurality of servers 12 can be caused to perform processing described below in a distributed manner. Furthermore, for the plurality of servers 12, corresponding terminals 11 are assigned, and each server 12 can be caused to perform processing only for the assigned terminal 11.

Moreover, the information processing system 10 can cause the terminal 11 to perform some or all of the processing to be performed by the server 12. In a case where the terminal 11 is caused to perform all the processing to be performed by the server 12, the information processing system 10 can be configured without the server 12.

The terminal 11 includes, for example, a personal computer (PC), a mobile terminal such as a smartphone and a smart glass, and the like, and is operated by a user.

For example, the user operates the terminal 11 at an arbitrary place such as a farm, and can input necessary information, for example, a target extended ecosystem or purpose information indicating a purpose (for example, the user wants to enjoy a specific ecosystem service) of constructing the extended ecosystem.

Each farm is provided with an agricultural field. In the agricultural field, one or more sensor units 21 and one or more work devices 22 are arranged.

The sensor unit 21 includes, for example, various sensors such as a camera, a distance measuring sensor, a temperature sensor, and a humidity sensor. The sensor unit 21 acquires state information (state information indicating a state of the ecosystem) regarding (each element of) the state of the ecosystem of the agricultural field by, for example, capturing an image, detecting a distance, detecting a temperature and detecting various types of physical amounts such as humidity. The sensor unit 21 transmits the state information to the terminal 11.

The work device 22 performs a work indicated by work information according to the work information transmitted from the terminal 11. Note that, in a case where the work device 22 includes a sensor that performs various types of sensing and can acquire state information indicating the state of the ecosystem, the work device 22 can transmit the state information to the terminal 11.

The terminal 11 transmits information input from the user, the state information transmitted from the sensor unit 21 (further, the work device 22), and other necessary information to the server 12 (via the network 14). The state information transmitted to the server 12 includes at least the biological diversity of the ecosystem of the agricultural field.

Furthermore, the terminal 11 receives, for example, an image as a presentation user interface (UI) that presents work information, and the like, transmitted from the server 12 (via the network 14). The terminal 11 can display, for example, the presentation UI, thereby presenting the work information, and the like, to the user.

The terminal 11 transmits the work information included in the presentation UI to the work device and causes the work device 22 to perform the work indicated by the work information. The terminal 11 transmits, to the server 12, the work information that is transmitted to the work device 22 and indicates the work actually caused to be performed.

Note that the state information can be directly transmitted from the sensor unit 21 to the server 12 instead of being transmitted from the terminal 11. Similarly, the work information indicating the work actually performed by the work device 22 can also be directly transmitted from the work device 22 to the server 12 instead of being transmitted from the terminal 11.

The server 12 receives the state information, the work information, and the like, transmitted from the terminal 11 (via the network 14). The server 12 stores the state information and the work information from the terminal 11 in the DB 13 (via the network 14).

The server 12 predicts a state of a post-work ecosystem in a case where the work indicated by the work information including a type of the work and a work parameter by the work device 22 is performed on the ecosystem by using the state information indicating the state of the ecosystem including the biological diversity of the ecosystem from the terminal 11. Further, the server 12 evaluates a prediction state which is the predicted state of the ecosystem and determines proposal work information which is work information to be proposed according to (on the basis of) an evaluation result of the prediction state.

The server 12 generates a presentation UI that presents the proposal work information, and the like, and transmits the presentation UI to the terminal 11 (via the network 14).

The server 12 refers to the DB 13 (via the network 14) as necessary and performs processing using the information stored in the DB 13.

The DB 13 stores the state information and the work information transmitted from the server 12 (via the network 14). For example, the server 12 transmits and stores the state information and the work information in the DB 13 in units of a set (hereinafter, also referred to as a data set) of pre-work state information, executed work information, and post-work state information.

The pre-work state information is state information indicating a state of the ecosystem before (immediately before) the work indicated by the work information is performed. The executed work information is work information indicating the work actually performed on the ecosystem in the state indicated by the pre-work state information. The post-work state information is state information indicating a state of the ecosystem after the work indicated by the executed work information is performed.

### Hardware Configuration Example of Terminal 11 and Server 12

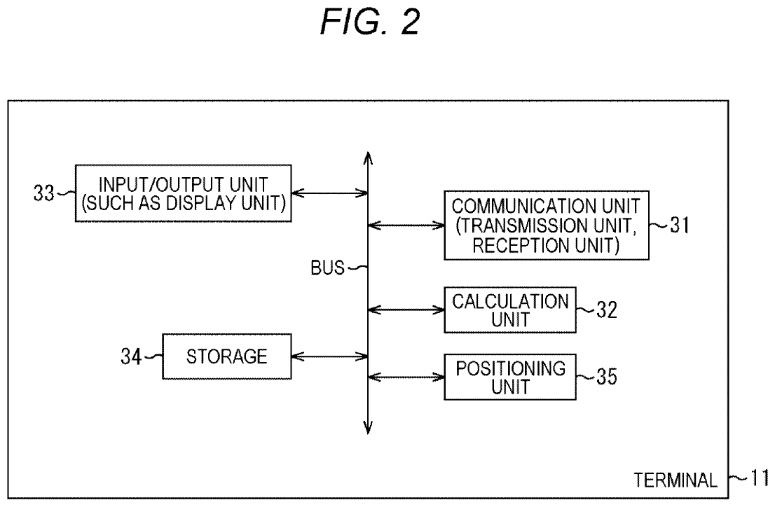

FIG. 2 is a view illustrating a hardware configuration example of the terminal 11.

The terminal 11 includes a communication unit 31, a calculation unit 32, an input/output unit 33, a storage 34, and a positioning unit 35. The communication unit 31 to the positioning unit 35 are connected to each other via a bus and can exchange information.

The communication unit 31 functions as a transmission unit that transmits information and a reception unit that receives information via the network 14.

The calculation unit 32 includes a processor such as a central processing unit (CPU) and a digital signal processor (DSP) and performs various types of processing by executing a program recorded in the storage 34.

The input/output unit 33 includes a keyboard, a touch panel, a microphone, and the like, and receives various inputs such as operation from the user. Furthermore, the input/output unit 33 includes a speaker and a display (display unit) and presents information to the user by outputting sound, displaying an image, or the like.

The storage 34 includes a semiconductor memory such as a random access memory (RAM) and a non-volatile memory, a solid state drive (SSD), a hard disk drive (HDD), and the like. The program to be executed by the calculation unit 32, data necessary for processing of the calculation unit 32, and the like, are recorded (stored) in the storage 34.

The program to be executed by the calculation unit 32 can be installed on a computer as the terminal 11 from a removable recording medium such as a digital versatile disc (DVD) and a memory card, for example. Furthermore, for example, the program can be downloaded to the computer as the terminal 11 via the network 14, or the like, and installed on the storage 34.

The positioning unit 35 constitutes, for example, a global positioning system (GPS), measures (determines) a position of the terminal 11 and outputs position information indicating the position, for example, latitude and longitude (and required altitude).

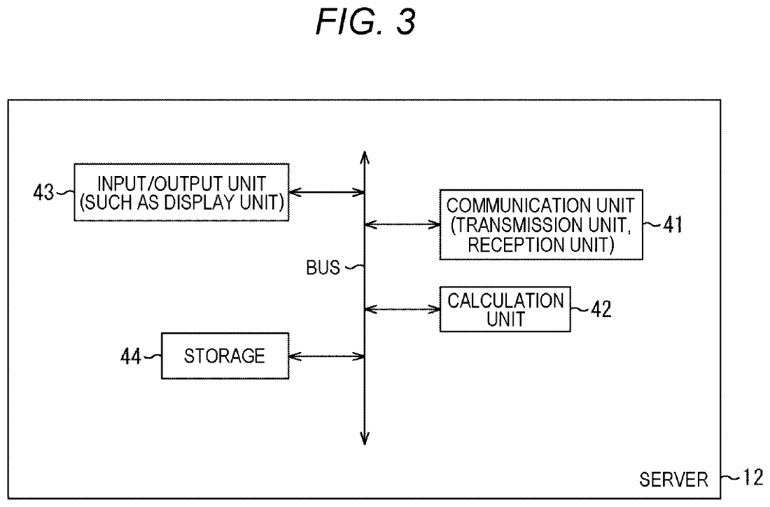

FIG. 3 is a view illustrating a hardware configuration example of the server 12.

The server 12 includes a communication unit 41, a calculation unit 42, an input/output unit 43, and a storage 44. The communication unit 41 to the storage 44 are configured in a similar manner to the communication unit 31 to the storage 34 in FIG. 2, respectively, and thus, the description thereof will be omitted. Note that, as the communication unit 41 to the storage 44 of the server 12, those having higher performance such as capacity and processing speed than the communication unit 31 to the storage 34 of the terminal 11 can be employed.

### Outline of Processing of Information Processing System 10

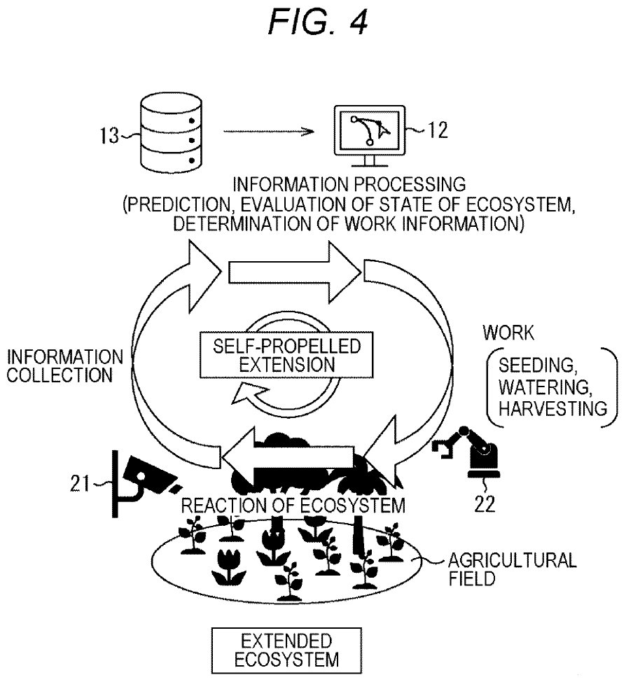

FIG. 4 is a view for explaining outline of processing of the information processing system 10.

The sensor unit 21 acquires state information indicating a state of the ecosystem of the agricultural field. The state information is stored in the DB 13 via the server 12, whereby information regarding the state information is collected.

Here, the ecosystem includes an organism and an environment (non-biological environment) surrounding the organism. Thus, the state of the ecosystem includes a state of the organism of the ecosystem and a state of the environment (non-biological environment) of the ecosystem.

Further, elements of the state of the ecosystem include biological diversity (based on observation) of each biological species such as plant species, animal species, and microbiota. Furthermore, elements of the state of the ecosystem include a coverage of each plant species (a proportion of the entire area of the ecosystem covered by the plant species), a biological index such as a biomass (amount or density) or a carbon amount, a macro and micro weather such as a temperature or humidity, a physical index such as a water amount of soil, water retainability, drainage, and a ground temperature, and a chemical index such as a component of the plant species, pH of soil, and various ion concentrations. In addition, the elements of the state of the ecosystem can include a position and a size (scale of the ecosystem) of (the area of) the ecosystem.

For example, the biological diversity, the coverage of each plant species, and the like, correspond to the state of the organism, and the weather, the water amount of soil, and the like, correspond to the state of the environment.

The state information for which the information is collected includes at least the biological diversity of the ecosystem. As the biological diversity, for example, the number (observed number) of observed biological species, specifically, the number of the observed plant species (number of the observed plant species), the number of the observed soil microorganism species, the number of the observed insect species, and the like, can be adopted. In addition, as the biological diversity, for example, the number of individuals of each observed biological species, specifically, the number of individuals of each plant species, the number of individuals of each soil microorganism species, the number of individuals of each insect species, and the like, can be adopted. In addition, as the biological diversity, for example, a systematic diversity index calculated on the basis of information regarding a phylogenetic tree of a biological species can be adopted for the observed biological species.

The server 12 predicts a state of the post-work ecosystem in a case where the work indicated by the work information is performed on the ecosystem in the state indicated by the state information acquired by the sensor unit 21 and evaluates a prediction state which is the predicted state. In accordance with the evaluation result of the prediction state, the server 12 determines the work information, or the like, indicating a work appropriate for construction of the target extended ecosystem as proposal work information which is the work information to be proposed, and transmits the proposal work information to the work device 22 via the terminal 11.

The work device 22 performs the work indicated by the proposal work information on the ecosystem of the agricultural field. The (proposal) work information indicating the actual work performed by the work device 22 is transmitted to and stored in the DB 13 via the server 12.

Here, the work indicated by the (proposal) work information includes, in addition to an agricultural work, a work that can affect the state of the ecosystem, for example, introduction of a specific insect species. Here, for example, thinning harvesting, seeding (introduction of seeds or seedlings), watering, and grass management described in “Synecoculture Manual, 2016 Version” edited by Masatoshi Funabashi are adopted as (the type of) the work.

By the work device 22 performing the work, the ecosystem appropriately reacts, and the state of theecosystem changes.

The sensor unit 21 acquires the state information indicating the state of the ecosystem after the work of the work device 22, and thereafter, similar processing is repeated.

As a result, the work information and the state information, that is, data sets which are sets of the pre-work state information, the executed work information, and the post-work state information are accumulated in the DB 13.

In prediction of the prediction state, the server 12 generates, from the data sets accumulated in the DB 13, a model representing a relationship between the pre-work state information and the (executed) work information, and the post-work state information, for example, a prediction model that has been learned using the pre-work state information and the work information as inputs and the post-work state information as an output. The server 12 predicts the prediction state of the ecosystem in a case where the work indicated by the work information is performed, using the prediction model.

Thus, as a result of the data sets being accumulated in the DB 13, prediction accuracy of the prediction state using the prediction model is improved. Thus, in addition to the work information indicating the work appropriate for constructing the target extended ecosystem, the server 12 can determine the work information for collecting the data sets as the proposal work information in order to improve the prediction accuracy.

As described above, in the information processing system 10, the proposal work information is determined using the state information including at least the biological diversity, so that it is possible to propose at least a work appropriate for construction of the extended ecosystem in which the biological diversity is enhanced.

Then, as a result of the work indicated by the proposal work information being performed on the ecosystem, an extended ecosystem in which at least the biological diversity is enhanced can be constructed.

Here, in management of the conventional agriculture, the purpose is uniquely determined for a growth level of the crop of agriculture, a state of the soil, a harvested amount, quality of harvested products, and the like, and the work for achieving the purpose is optimized.

On the other hand, in management of the extended ecosystem, a feedback mechanism capable of determining a work to be proposed in consideration of the state of the ecosystem sequentially changing as the extended ecosystem is constructed and the work related to the change is necessary. Furthermore, in a case where an appropriate work for constructing the extended ecosystem is determined, at least the biological diversity should be considered in consideration of the state of the (extended) ecosystem.

The information processing system 10 includes a feedback mechanism that repeats collection of the state information of the ecosystem including at least biological diversity, prediction of the prediction state of the ecosystem after the work by using the state information, evaluation of the prediction state, determination of the work to be proposed according to an evaluation result, and collection of the state information of the ecosystem after the work is performed. This makes it possible to propose a work appropriate for construction of the extended ecosystem.

As described above, constructing the extended ecosystem by repeating collection of the information regarding the state of the ecosystem, prediction and evaluation of the state of the ecosystem after the work by using the state of the ecosystem, determination of the work according to an evaluation result, and collection of the information regarding the state of the ecosystem after the work is performed is referred to as self-propelled extension.

### Data Set

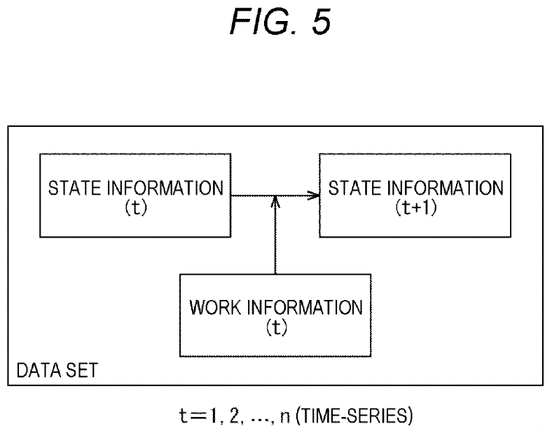

FIG. 5 is a view for explaining a data set stored in the DB 13.

The state information and the work information are time-series information, and the state information and the work information at a certain time point (time) t are expressed as state information (t) and work information (t), respectively.

In a case where it is assumed that the work indicated by the work information (t) is performed on the ecosystem in the state indicated by the state information (t), the state information (t+1) indicates the state of the ecosystem after the work indicated by the work information (t) is performed.

In this case, the state information (t) is the pre-work state information, and the work information (t) is the executed work information. The state information (t+1) is the post-work state information.

The DB 13 stores the state information and the work information in units of a data set which is a set of the state information (t) which is the pre-work state information, the work information (t) which is the executed work information, and the state information (t+1) which is the post-work state information.

The server 12 generates a prediction model using the state information (t) that is the pre-work state information and the work information (t) that is the executed work information as explanatory variables and using the state information (t+1) that is the post-work state information as an objective variable. The prediction model is a model that receives the pre-work state information and the executed work information as inputs and outputs post-work state information indicating a state (prediction state) of the ecosystem after the work after the work indicated by the executed work information is performed.

Note that the elements of (the state of the ecosystem indicated by) the pre-work state information that are to be the inputs of the prediction model may be the same as or do not have to be the same as the elements of the post-work state information that are to be the outputs of the prediction model. For example, as the elements of the post-work state information, elements obtained by excluding some elements from the elements of the pre-work state information can be adopted. For example, in a case where the elements of the pre-work state information include a position, a size, and a climate zone of the ecosystem, elements obtained by excluding the position, the size, and the climate zone of the ecosystem can be adopted as the elements of the post-work state information.

Furthermore, as the pre-work state information of the data set, in addition to the state information (t) indicating the state of the ecosystem immediately before the work indicated by the work information (t) is performed, the state information (t−1), the state information (t−2), . . . , indicating the past states of the ecosystem can be further adopted.

In this case, the prediction model can be generated using the state information (t), the state information (t−1), the state information (t−2), and the work information (t) as explanatory variables and the state information (t+1) as an objective variable. In a case where the prediction model is generated using the state information (t), the state information (t−1), the state information (t−2), and the work information (t) as explanatory variables and the state information (t+1) as an objective variable, the prediction accuracy of the prediction state of the ecosystem after the work by the prediction model can be improved.

### Work Device 22

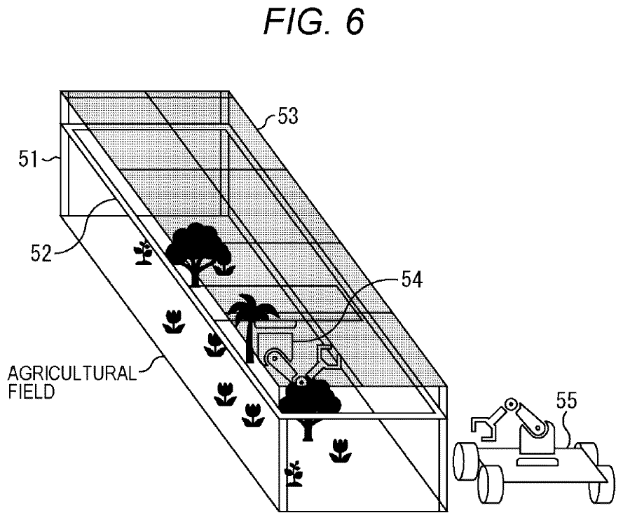

FIG. 6 is a view illustrating an example of the work device 22.

In FIG. 6, pillars 51 are fixed to four corners of the rectangular agricultural field. A rail 52 is fixed to the two pillars 51 facing each other in a longitudinal direction of the rectangle of the agricultural field from one pillar 51 to the other pillar 51 at a predetermined height of the pillar 51. In an upper portion of the agricultural field, a rectangular solar panel 53 at least part of which is (semi-) transparent is fixed to upper ends of the pillars 51 so as to cover the agricultural field, so that so-called solar sharing is performed.

The work device 22 can be caused to operate using part of power generated by the solar panel 53 as a power source.

A robot 54 can move along the rail 52 and perform a work on an arbitrary position in the agricultural field.

The robot 54 moving along the rail 52 is described in, for example, Japanese Patent Application Laid-Open No. 2021-118737.

A robot 55 can move on the ground and perform a work on an arbitrary position in the agricultural field.

The robots 54 and 55 are equipped with a work mechanism that performs a predetermined work. As a work mechanism, for example, there is a robot arm that can carry general supplies described in Japanese Patent Application Laid-Open No. 2021-87369. Further, as the work mechanism, for example, there is a manipulator to which a mining machine, a seed spreading mechanism, pruning scissors, a mower, and the like, are attached at the distal end.

The robots 54 and 55 as described above can be employed as the work devices 22. Furthermore, as the work device 22, for example, a device that moves in the air such as a drone can be adopted. In addition, as the work device 22, a device fixed to an agricultural field (ecosystem) can be adopted.

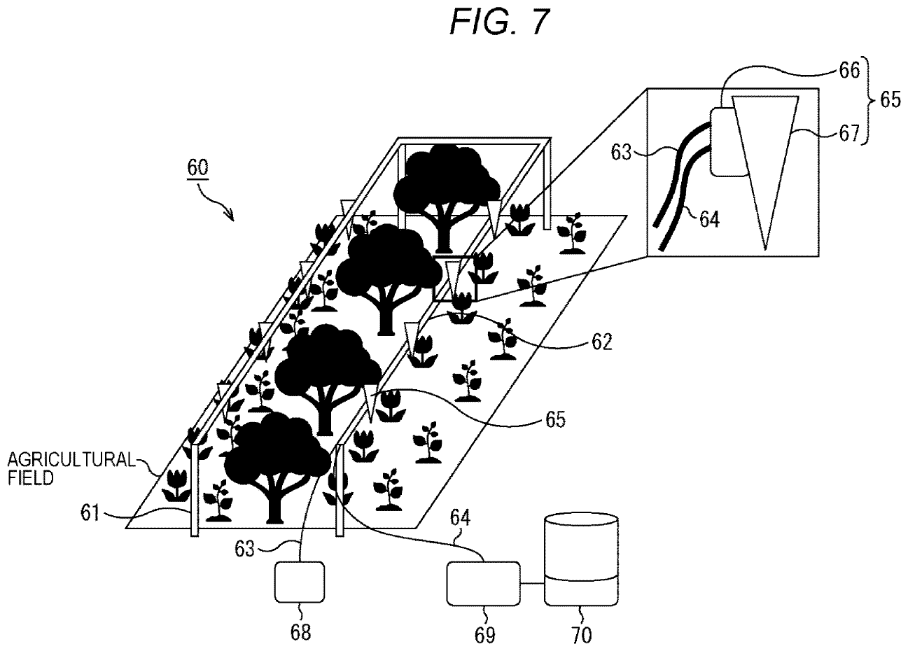

FIG. 7 is a view illustrating another example of the work device 22.

FIG. 7 illustrates an example of a watering device.

In FIG. 7, a watering device 60 includes pillars 61, a pipe 62, a communication cable 63, a water pipe 64, water spray nozzles 65, a nozzle control device 68, a water supply pump 69, and a water tank 70, and is fixed to the agricultural field.

Two pillars 61 are fixed at a predetermined distance on one short side of the rectangular agricultural field, and two pillars 61 are also fixed on the other short side so as to face the pillars 61 on the one short side.

The pipe 62 is fixed in a U-shape from one pillar 61 on one short side to the other pillar 61 on the other short side, the other pillar 61 on the other short side, and the other pillar 61 on the one short side at a predetermined height of the pillar 61. A plurality of water spray nozzles 65 is fixed at the pipe 62.

The communication cable 63 is a cable that transmits an electric signal output from the nozzle control device 68 and is connected to the nozzle control device 68. Further, the communication cable 63 is connected to the water spray nozzles 65 fixed at the pipe 62 through the inside of the pipe 62.

A control signal that is an electric signal output from nozzle control device 68 is transmitted to the water spray nozzles 65 via the communication cable 63 passing through the pipe 62, whereby the water spray nozzles 65 are controlled.

The water pipe 64 is connected to the water supply pump 69, and is further connected to the water spray nozzles 65 fixed at the pipe 62 through the inside of the pipe 62.

Water discharged from the water supply pump 69 is supplied to the water spray nozzles 65 via the water pipe 64 passing through the pipe 62, whereby water is discharged (sprayed) from the water spray nozzles 65.

The water spray nozzle 65 includes a nozzle opening and closing device 66 and a nozzle 67.

The communication cable 63 passing through the pipe 62 and the water pipe 64 are connected to the nozzle opening and closing device 66. The nozzle opening and closing device 66 supplies water from the water supply pump 69 supplied via the water pipe 64 to the nozzle 67.

Furthermore, the nozzle opening and closing device 66 performs control to open and close the nozzle 67 in accordance with a control signal from the nozzle control device 68 transmitted via the communication cable 63.

The nozzle 67 is opened and closed according to the control of the nozzle opening and closing device 66 and outputs water from the nozzle opening and closing device 66.

The nozzle control device 68 transmits a control signal for controlling the nozzle opening and closing device 66 to the nozzle opening and closing device 66 via the communication cable 63.

The water supply pump 69 supplies water stored in the water tank 70 to the nozzle opening and closing device 66 via the water pipe 64.

The water tank 70 stores water.

As the work device 22, the watering device 60 fixed to the agricultural field (ecosystem) configured as described above can be adopted.

### First Functional Configuration Example of Server 12

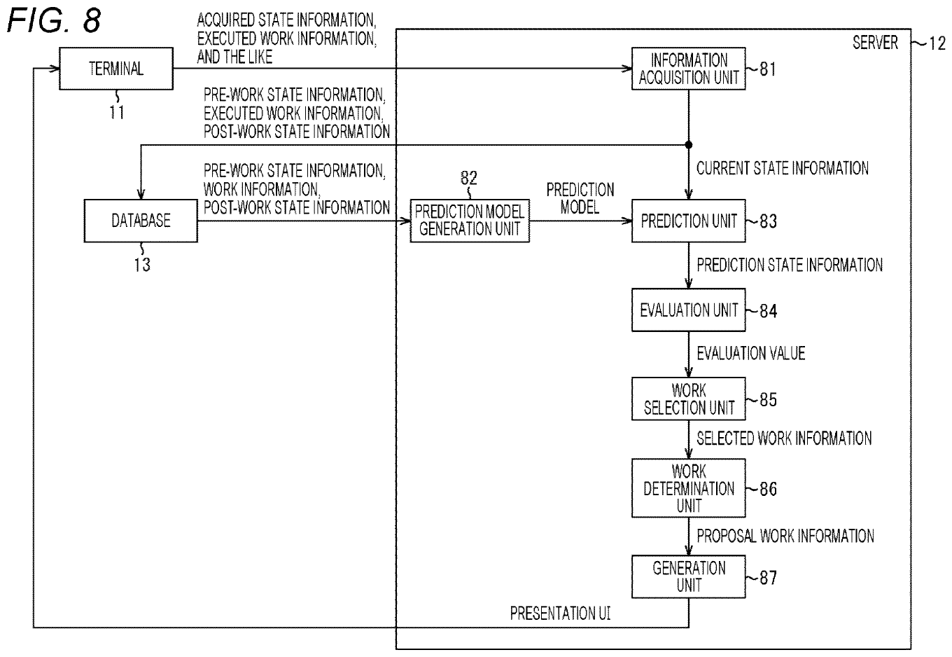

FIG. 8 is a block diagram illustrating a first functional configuration example of the server 12.

The functional configuration of the server 12 is functionally implemented by the program being executed by the calculation unit 42 in FIG. 3.

The server 12 includes an information acquisition unit 81, a prediction model generation unit 82, a prediction unit 83, an evaluation unit 84, a work selection unit 85, a work determination unit 86, and a generation unit 87.

The information acquisition unit 81 acquires information necessary for processing of the server 12 from the terminal 11 or the outside such as the Internet. For example, the information acquisition unit 81 acquires information transmitted from the terminal 11, for example, the state information (hereinafter, also referred to as acquired state information) acquired by the sensor unit 21, the executed work information which is work information indicating the work actually performed (executed) on the ecosystem by the work device 22, and the like.

The information acquisition unit 81 supplies, to the prediction unit 83 as current state information, the acquired state information indicating a state at a time point when the work is to be proposed, for example, a current state, of the ecosystem (hereinafter, also referred to as a target ecosystem) of an area (hereinafter, also referred to as a target area) in which the work (information) is to be proposed among the acquired stateinformation.

In addition, the information acquisition unit 81 acquires a data set which is a set of the pre-work state information, the executed work information, and the post-work state information from the acquired state information and the executed work information, and stores the data set in the DB 13. In other words, the information acquisition unit 81 acquires, as the pre-work state information, the acquired state information indicating the state of the ecosystem before the work indicated by the executed work information is performed among the acquired state information. Further, the information acquisition unit 81 acquires, as the post-work state information, the acquired state information indicating the state of the ecosystem after the work in a case where the work indicated by the executed work information is performed among the acquired state information. Then, the information acquisition unit 81 stores a data set, which is a set of the pre-work state information, the executed work information, and the post-work state information, in the DB 13.

The prediction model generation unit 82 generates a prediction model by performing learning of a prediction model using the data set stored in the DB 13 as learning data to be used for learning, the pre-work state information and (executed) work information as inputs, and the post-work state information as an output. As the prediction model, any model, for example, a regression model, a machine learning model, or the like, can be adopted.

The prediction unit 83 uses the current state information from the information acquisition unit 81 to predict the state of the ecosystem after the work in a case where the work by the work device 22 is performed on the ecosystem, that is, predict the prediction state. The prediction unit 83 uses the prediction model from the prediction model generation unit 82 in prediction of the prediction state. The prediction model is generated using the data set as the learning data, so that it can be said that the prediction of the prediction state is performed using the data set. The prediction accuracy can be improved by predicting the prediction state using the data set, that is, the state information indicating the state of the ecosystem actually observed and the work information indicating the work actually performed on the ecosystem.

The prediction unit 83 generates a plurality of pieces of work information (hereinafter, also referred to as candidate work information) respectively representing a plurality of work candidates.

Here, the work information includes (information regarding) a type of the work and a work parameter indicating a condition of the work. The condition of the work includes, for example, a frequency and a flow rate of watering, a frequency and a degree (such as an amount of seeds to be seeded by seeding and a proportion of seeds to be harvested by thinning harvesting) of harvesting and seeding, and a period during which the work is performed.

The prediction unit 83 generates a plurality of pieces of candidate work information by setting one or more work parameters for each type of the work determined in advance, such as, for example, thinning harvesting, seeding (introduction of seeds or seedlings) and watering.

The candidate work information indicating the thinning harvesting (the candidate work information in which the thinning harvesting is set as the type of work) is generated for the plant species existing in the ecosystem on which the work is to be performed. For example, in a case where carrots, radishes, and turnips are present in the ecosystem, candidate work information indicating thinning harvesting of carrots, candidate work information indicating thinning harvesting of radishes, and candidate work information indicating thinning harvesting of turnips are generated.

In addition, for the candidate work information indicating the thinning harvesting, for example, a value within a range that can be (theoretically) taken as a ratio of harvesting by the thinning harvesting (hereinafter, also referred to as a thinning harvesting rate) is appropriately set as the work parameter. For example, in the thinning harvesting of carrots with a thinning harvesting rate of 50%, 50% of the carrots growing in the ecosystem are harvested (eliminated), and immediately after harvesting, a coverage of the carrots in the ecosystem is reduced by 50%.

A possible range of the thinning harvesting rate is 0 to 100%, and thus, for example, 0%, 10%, and 100% are set as the work parameter. Thus, for example, as the work information indicating the thinning harvesting of carrots, 11 pieces of candidate work information indicating the thinning harvesting rates of 0%, 10%, and 100% as the work parameters are generated. For example, in a case where the thinning harvesting rate is 0%, the carrots present in the ecosystem are not harvested. In addition, for example, in a case where the thinning harvesting rate is 100%, all the carrots existing in the ecosystem are harvested.

The candidate work information indicating seeding is generated for a predetermined plant species. For example, in a case where carrots, radishes, and turnips are present as predetermined plant species, candidate work information indicating seeding of carrots, candidate work information indicating seeding of radishes, and candidate work information indicating seeding of turnips are generated.

In addition, for the candidate work information indicating seeding, for example, a value within a range in which the work device 22 can perform the work or a plurality of predetermined values (or two or more values selected from the plurality of values) is appropriately set as the work parameter.

For example, in a case where the work device 22 is capable of seeding a value in the range of 0 to 10 mL/m\hat{ }2 in increments of 1 mL/m\hat{ }2 as an amount of seeding per unit time, for example, 0 mL/m\hat{ }2, 1 mL/m\hat{ }2, 2 mL/m\hat{ }2, ..., 10 mL/m\hat{ }2 are set as the work parameter. Alternatively, for example, as the amount of seeding, 0 mL/m\hat{ }2, 1 mL/m\hat{ }2, 3 mL/m\hat{ }2, . . . , 9 mL/m\hat{ }2, 0 mL/m\hat{ }2, 2 mL/m\hat{ }2, 4 mL/m\hat{ }2, . . . , 10 mL/m\hat{ }2, or the like, is set as the work parameter.

In addition, for example, in a case where four values of once a week, twice a week, once a month, and twice a month are determined in advance as a frequency of seeding, for example, the four values of once a week, twice a week, once a month, and twice a month are set as the work parameter.

For each of the plurality of pieces of candidate work information, the prediction unit 83 predicts the state (prediction state) of the target ecosystem after the work in a case where the work indicated by the candidate work information is performed on the target ecosystem indicated by the current state information by using the prediction model and supplies the prediction state information indicating the prediction state to the evaluation unit 84.

In other words, the prediction unit 83 inputs the candidate work information and the current state information to the prediction model, acquires an output of the prediction model with respect to the input as prediction state information indicating a prediction state obtained by predicting the state of the target ecosystem after the work indicated by the candidate work information, and supplies the prediction state information to the evaluation unit 84.

The evaluation unit 84 evaluates the state of the ecosystem indicated by the prediction state information for each of the plurality of pieces of candidate work information from the prediction unit 83, that is, the state of the ecosystem after the work in a case where the work indicated by the candidate work information is performed. evaluating the state of the ecosystem. For example, the evaluation unit 84 sets an evaluation method for evaluating at least the biological diversity of the state of the ecosystem. As the evaluation method for evaluating the state of the ecosystem, for example, a predetermined evaluation method can be set. Furthermore, for example, in a case where purpose information is transmitted from the terminal 11, the evaluation method can be set according to the purpose information.

The setting of the evaluation method means, for example, setting items related to evaluation such as an element to be used for evaluating the state of the ecosystem and a calculation method for calculating an evaluation value as an evaluation result of the state of the ecosystem (such as an evaluation calculation formula for calculating the evaluation, and a model to be used for the calculation) among the elements of the state of the ecosystem (for example, biological diversity, a coverage of a specific plant species, and the like).

For example, in a case where the purpose information indicates the purpose to construct an ecosystem in a state where species diversity of each of the plant species and the soil microorganism species is high, and the soil humidity is high, in the setting of the evaluation method, for example, Formula X=the number of the observed plant species * the number of the observed soil microorganism species * the soil humidity can be set as the evaluation calculation formula for calculating the evaluation value X.

Furthermore, for example, in a case where the purpose information indicates the purpose to improve biomass density (gram/m\hat{ }3) of vegetation per unit space and a diversity degree (taxonomic diversity of observed species) of the observed species (observed species) throughout the year, for example, X=αt+1/αt*βt+1/βt can be set as the evaluation calculation formula in the setting of the evaluation method.

αt+1 and βt+1 respectively represent the biomass density and the diversity degree of the observed species included as elements in the prediction state information, that is, the prediction values of the biomass density and the diversity degree of the observed species of the target ecosystem at the time point t+1 after the work in a case where the work indicated by the candidate work information is performed on the target ecosystem. αt and βt respectively represent the biomass density and the diversity degree of the observed species included as elements in the current state information, that is, the biomass density and the diversity degree of the observed species of the target ecosystem at the time point t before the work indicated by the candidate work information is performed on the target ecosystem.

As described above, in a case where the evaluation method of evaluating the state of the ecosystem is set according to the purpose information, the user can define the state of the target ecosystem and can determine the proposal work information indicating the work appropriate for (the directionality of) construction of the ecosystem in the state.

The evaluation unit 84 calculates an evaluation value of the state (prediction state) of the ecosystem indicated by the prediction state information for each of the plurality of pieces of candidate work information from the prediction unit 83 according to the set evaluation method, for example, the evaluation calculation formula, and supplies the evaluation value to the work selection unit 85. Note that a greater evaluation value indicates higher evaluation, for example.

The work selection unit 85 selects selected work information from a plurality of pieces of candidate work information according to the evaluation value from the evaluation unit 84. For example, it is possible to select, as the selected work information, one piece of candidate work information having the highest evaluation value or a plurality of N pieces of candidate work information having higher evaluation values.

In a case where N pieces of selected work information are selected, the work selection unit 85 can narrow down the N pieces of selected work information to M pieces of selected work information, where M is a value less than N and equal to or greater than 2. For example, in a case where the target area is divided (or can be divided) into M sub-areas as areas where work is to be performed, the N pieces of selected work information can be narrowed down to M pieces of selected work information less than N.

The selected work information can be narrowed down, for example, so as to obtain a diversified state of the target ecosystem of the target area after the work in a case where the work indicated by the narrowed down M pieces of selected work information is performed, for example, so as to improve the biological diversity.

For example, it is assumed that the state information includes at least the number of the observed plant species, the number of the observed soil microorganism species, the soil humidity, and the number of individuals of each insect species as elements, and the above-described formula X=the number of the observed plant species * the number of the observed soil microorganism species * the soil humidity is set as the evaluation calculation formula of the evaluation value X. Furthermore, it is assumed that the number of individuals of each insect species has almost no correlation with the evaluation value X and has almost no influence on the evaluation value X.

In this case, in the narrowing down of the selected work information, it is possible to select M pieces of selected work information in which compositions of the number of individuals of each insect species included in the prediction state information are different from each other as much as possible from among the N pieces of selected work information with higher evaluation values X.

Such selection can be performed, for example, by classifying N pieces of selected work information into clusters according to the compositions of the number of individuals of each insect species, and selecting M pieces of selected work information from as different clusters as possible. For example, in a case where N pieces of selected work information are classified into M clusters, M pieces of selected work information can be selected by selecting one piece of selected work information from each of the M clusters. The classification of the selected work information into clusters can be performed, for example, by calculating dissimilarity (or similarity) of the compositions of the number of individuals of each insect species using the number of individuals of each insect species as a variable, and performing cluster analysis, or the like, using the dissimilarity.

According to the narrowing down of the selected work information as described above, the selected work information in which the compositions of the number of individuals of each insect species are predicted to be as different as possible in the target ecosystem after the work is selected. Thus, the compositions of the number of individuals of each insect species converge to a partial range, and the environment of the ecosystem also converges to a partial range, so that it is possible to suppress loss of the biological diversity.

The work selection unit 85 supplies the selected work information (in a case where the narrowing down has been performed, the selected work information after the narrowing down has been performed) to the work determination unit 86.

The work determination unit 86 determines proposal work information that is work information to be proposed according to the selected work information from the work selection unit 85. Here, the work determination unit 86 determines the proposal work information by using the selected work information selected according to the evaluation value, so that it can be said that the proposal work information is determined according to the evaluation value.

The work determination unit 86 determines evaluation improvement work information indicating a work of improving (predicted to improve) the evaluation of the state of the target ecosystem according to the selected work information.

For example, the work determination unit 86 can determine the selected work information as the evaluation improvement work information as it is. In addition, for example, the work determination unit 86 can determine, as the evaluation improvement work information, one or more of pieces of peripheral work information which is work information having a peripheral value of the work parameter of the selected work information (work information having a high evaluation (value) ) as the work parameter.

The work determination unit 86 determines the evaluation improvement work information as the proposal work information.

In a case where the target area is divided (or can be divided) into a plurality of sub-areas, the work determination unit 86 can assign the proposal work information to the sub-areas, and includes information regarding the assignment in the proposal work information. The work indicated by the proposal work information is performed in the sub-area to which the proposal work information is assigned.

The work determination unit 86 can determine, as the proposal work information, extension work information to be described later in addition to the evaluation improvement work information (selected work information or peripheral work information).

The work determination unit 86 supplies the proposal work information to the generation unit 87.

The generation unit 87 generates a presentation UI that presents the proposal work information, and the like, from the work determination unit 86, that is, a presentation UI for the target area that presents the work information, and the like, indicating the work to be proposed as the work to be performed on the ecosystem of the target area, and transmits the presentation UI to the terminal 11, and the like.

### DB Space

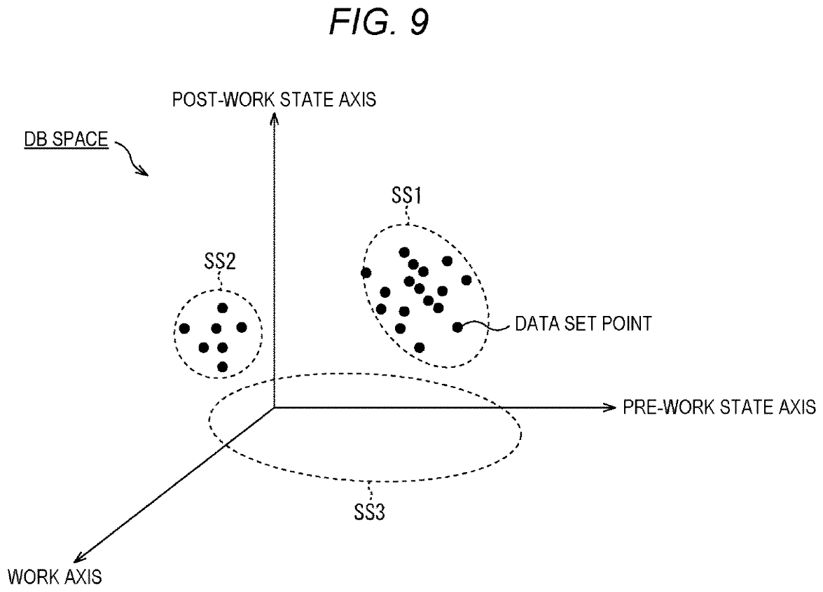

FIG. 9 is a view for explaining a DB space.

The prediction accuracy with which the prediction model predicts the prediction state is (tends to be) improved as the number of data sets is larger, the data set being a set of the information in the DB 13, that is, the pre-work state information, the (executed) work information indicating the work performed on the ecosystem in the state indicated by the pre-work state information, and the post-work state information indicating the state of the -39 ecosystem after the work indicated by the work information is performed.

If a three-dimensional space around each of the pre-work state information, the work information, and the post-work state information is referred to as a DB space, the data set is represented by a point in the DB space. A point in the DB space representing the data set is referred to as a data set point. Further, axes of the pre-work state information, the work information, and the post-work state information defining the DB space are referred to as a pre-work state axis, a work axis, and a post-work state axis, respectively.

The prediction accuracy of the prediction state of the prediction model becomes higher with respect to the input of the pre-work state and the work information included in partial spaces SS1 and SS2 in which the data set points in the DB space of FIG. 9 are dense. On the other hand, the prediction of the prediction model is low for the input of the pre-work state and the work information included in a partial space SS3 in which the data set points in the DB space are coarse.

Collecting data sets (sets of the pre-work state information, the work information, and the post-work state information) so as to fill the DB space with data set points is also referred to as extension of the DB 13. With the extension of the DB13, the accuracy of the prediction state of the prediction model is improved.

### Determination of Proposal Work Information and Assignment of Proposal Work Information to Sub-Areas

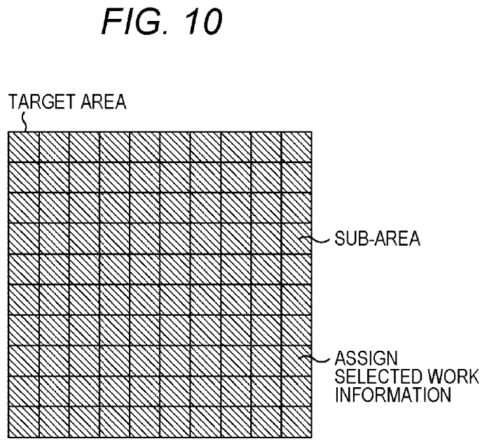

FIG. 10 is a view for explaining a first example of determination of the proposal work information and assignment of the proposal work information to sub-areas.

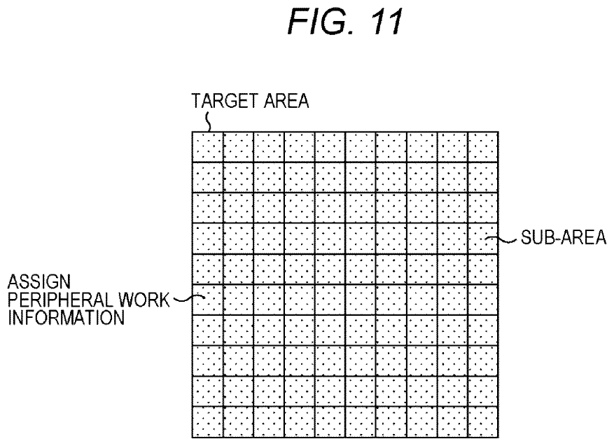

FIG. 10 illustrates an example of the target area. In FIG. 10, the target area is equally divided into a plurality of sub-areas, for example, 100 (sections) sub-areas. This similarly applies to FIG. 11 to FIG. 13 as described later.

For example, in a case where the target area is a farm having a plurality of agricultural fields, one agricultural field can be set as the sub-area. In addition, for example, each region obtained by dividing the agricultural field into several regions, one ridge of the agricultural field, or a plurality of ridges collectively formed in the agricultural field can be set as the sub-area. Furthermore, for example, in a case where a plurality of farms in a certain area is set as the target area, each farm, an agricultural field of each farm, or the like, can be set as the sub-area.

As described with reference to FIG. 8, the work determination unit 86 can determine the selected work information as the evaluation improvement work information. Then, the work determination unit 86 can determine only the evaluation improvement work information as the proposal work information. In this case, the proposal work information is only the selected work information.

In a case where the proposal work information is only the selected work information, as illustrated in FIG. 10, the work determination unit 86 can assign the selected work information to each of the 100 sub-areas.

Here, as the selected work information, one piece of candidate work information having the highest evaluation value can be selected, or a plurality of pieces of candidate work information having higher evaluation values can be selected. Thus, there are a case where there is only one piece of selected work information and a case where there is a plurality of pieces of selected work information.

In a case where there is only one piece of selected work information, the one piece of selected work information can be assigned to each of the 100 sub-areas.

In this case, the work information assigned to the 100 sub-areas is the same work information.

On the other hand, in a case where there is a plurality of pieces of selected work information, each of the plurality of pieces of selected work information can be assigned to 100 sub-areas.

The plurality of pieces of selected work information of the number equal to or less than the number of sub-areas can be prepared. For example, in a case where 100 pieces of selected work information equal to the number of sub-areas are prepared, 100 pieces of selected work information can be respectively assigned to 100 sub-areas. In addition, for example, in a case where L pieces of selected work information less than the number of sub-areas are prepared, the L pieces of selected work information can be respectively assigned to L sub-areas among 100 sub-areas.

The selected work information arbitrarily selected from the L pieces of selected work information for each sub-area can be assigned to the remaining 100-L sub-areas.

Note that in a case where the proposal work information is assigned to the sub-areas, the information acquisition unit 81 acquires a data set not for the entire target area but for each sub-area, and stores the data sets in the DB 13. In other words, the information acquisition unit 81 acquires a data set including state information indicating the state of the ecosystem of the sub-area before the work indicated by the proposal work information assigned to the sub-area is performed, work information indicating the work performed on the ecosystem of the sub-area (proposal work information assigned to the sub-area), and state information indicating the state of the ecosystem of the sub-area after the work, and stores the data set in the DB 13.

FIG. 11 is a view for explaining a second example of determination of the proposal work information and assignment of the proposal work information to the sub-areas.

As described with reference to FIG. 8, the work determination unit 86 can determine, as the evaluation improvement work information, one or more pieces of peripheral work information having a peripheral value of the work parameter of the selected work information as the work parameter. Then, the work determination unit 86 can determine only the evaluation improvement work information as the proposal work information. In this case, the proposal work information is only one or more pieces of the peripheral work information.

In a case where the proposal work information is only one or more pieces of the peripheral work information, as illustrated in FIG. 11, the work determination unit 86 can assign each of the one or more pieces of the peripheral work information to 100 sub-areas.

One or more pieces of the peripheral work information of the number equal to or less than the number of sub-areas can be prepared. For example, in a case where 100 pieces of the peripheral work information equal to the number of sub-areas are prepared, 100 pieces of peripheral work information can be respectively assigned to 100 sub-areas.

In addition, for example, in a case where L pieces of the peripheral work information less than the number of sub-areas are prepared, the L pieces of the peripheral work information can be assigned to L sub-areas among 100 sub-areas. The peripheral work information arbitrarily selected from the L pieces of the peripheral work information can be assigned to the remaining 100-L sub-areas for each sub-area.

One or more pieces of the peripheral work information having a peripheral value of the work parameter of the selected work information as the work parameter can be prepared (generated), for example, by using as a probability distribution of the work parameter, a normal distribution in which the work parameter of the selected work information is set as an average value and a predetermined value is set as a standard deviation o, and selecting the one or more work parameters as the work parameter of the peripheral work information with a probability according to the probability distribution.

The standard deviation o of the probability distribution of the work parameter can be set in advance in the server 12 or can be set according to the operation of the terminal 11 by the user, for example. In a case where the user desires the peripheral work information in which the work parameter is selected from a wide range, the standard deviation o may be set to a large value, and in a case where the user desires the peripheral work information in which the work parameter is selected from a narrow range, the standard deviation o may be set to a small value.

As described above, in a case where the selected work information or the peripheral work information having a peripheral value of the work parameter of the selected work information as the work parameter is determined as the evaluation improvement work information and eventually as the proposal work information, the work indicated by the proposal work information is performed, whereby the evaluation value of the state of the ecosystem can be (is highly likely to be) increased.

Furthermore, in a case where a plurality of pieces of the peripheral work information is determined as the proposal work information, the work indicated by the proposal work information is performed, so that it is possible to increase the evaluation value of the state of the ecosystem, collect the data sets filling the DB space, and extend the DB 13.

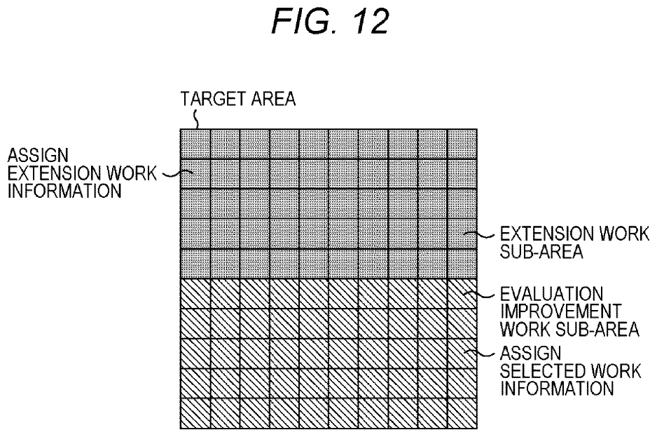

FIG. 12 is a view for explaining a third example of determination of the proposal work information and assignment of the proposal work information to the sub-areas.

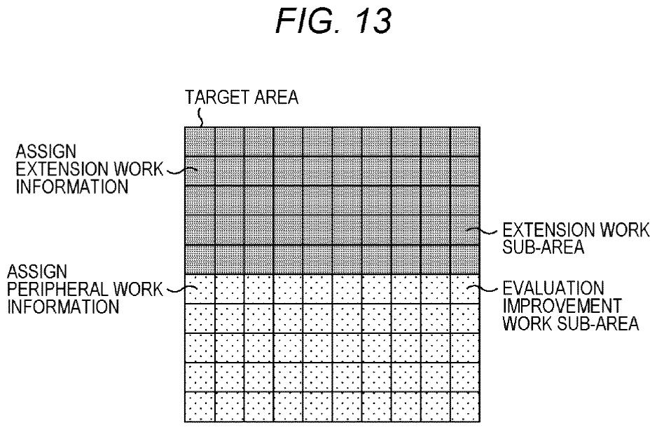

FIG. 13 is a view for explaining a fourth example of determination of the proposal work information and assignment of the proposal work information to the sub-areas.

As described with reference to FIG. 8, the work determination unit 86 can determine the extension work information as the proposal work information in addition to the evaluation improvement work information (selected work information or peripheral work information).

The extension work information is work information for extending the DB 13. For example, the work information in which the work parameter of the selected work information is randomly changed or the work information corresponding to a partial space in which the distribution of the data set points is coarse in the DB space can be adopted as the extension work information.

In a case where the evaluation improvement work information and the extension work information are determined as the proposal work information, the work determination unit 86 sets an extension ratio.

The extension ratio is a ratio of an area to which the extension work information is assigned in the target area, and is, for example, [the number of sub-areas to which the extension work information is assigned]/[the total number of sub-areas]. The extension ratio can be set in advance in the server 12 or can be set according to operation of the terminal 11 by the user, for example.

Among the sub-areas of the target area, the sub-areas corresponding to the extension ratio become extension work sub-areas to which the extension work information is assigned, and the remaining sub-areas become evaluation improvement work sub-areas to which the evaluation improvement work information is assigned.

For example, in a case where the extension ratio is set to 0.5, 50 sub-areas out of 100 sub-areas of the target area become the extension work sub-areas, and the remaining 50 sub-areas become the evaluation improvement work sub-areas. In addition, for example, in a case where the extension ratio is set to 1, all 100 sub-areas of the target area become the extension work sub-areas, and in a case where the extension ratio is set to 0, all 100 sub-areas of the target area become the evaluation improvement work sub-areas. FIGS. 12 and 13 illustrate a case where the extension ratio is set to 0.5.

As the evaluation improvement work information to be determined as the proposal work information, one or more pieces of evaluation improvement work information can be prepared, the number being equal to or smaller than the number L11 of evaluation improvement work sub-areas, that is, the number L12. L12 pieces of evaluation improvement work information can be respectively assigned to L12 evaluation improvement work sub-areas among 100 sub-areas.

To the remaining L11-L12 evaluation improvement work sub-areas, evaluation improvement work information arbitrarily selected from L12 pieces of evaluation improvement work information can be assigned for each sub-area.

Similarly, as the extension work information to be determined as the proposal work information, one or more pieces of extension work information can be prepared, the number being equal to or smaller than the number L21 of extension work sub-areas, that is, the number L22. L22 pieces of extension work information can be respectively assigned to L22 pieces of extension work sub-areas among 100 sub-areas. To the remaining L21-L22 extension work sub-areas, extension work information arbitrarily selected from L22 pieces of extension work information can be assigned for each sub-area.

FIG. 12 illustrates an example of assignment of the evaluation improvement work information and the extension work information determined as the proposal work information to the sub-areas in a case where the evaluation improvement work information is the selected work information. The extension work information is assigned to 50 extension work sub-areas among 100 sub-areas, and the selected work information is assigned to the remaining 50 evaluation improvement work sub-areas. The first example of FIG. 10 corresponds to a case where the extension ratio is set to 0 (a case where there is no extension work sub-area) in the third example of FIG. 12.

FIG. 13 illustrates an example of assignment of the evaluation improvement work information and the extension work information determined as the proposal work information to the sub-areas in a case where the evaluation improvement work information is the peripheral work information. The extension work information is assigned to 50 extension work sub-areas among 100 sub-areas, and the peripheral work information is assigned to the remaining 50 evaluation improvement work sub-areas. The second example of FIG. 11 corresponds to a case where the extension ratio is set to 0 in the fourth example of FIG. 13.

As described above, in a case where the evaluation improvement work information and the extension work information are determined as the proposal work information, the evaluation value of the state of the ecosystem can be (is highly likely to be) increased by performing the work indicated by the evaluation improvement work information. Furthermore, if as a result of the work indicated by the extension work information being performed, the data sets that fill the partial space in which the distribution of the data set points is coarse are collected in the DB space, the DB 13 can be extended.

### Processing of Server 12

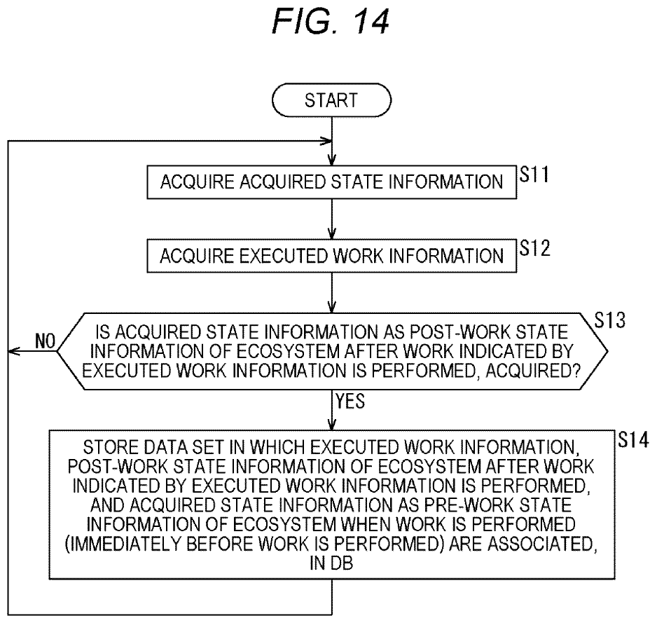

FIG. 14 is a flowchart for explaining an example of processing of the server 12 storing information in the DB 13.

In step S11, in a case where acquired state information is transmitted from the terminal 11, the information acquisition unit 81 acquires the acquired state information by receiving the acquired state information, and the processing proceeds to step S12.

In step S12, in a case where executed work information is transmitted from the terminal 11, the information acquisition unit 81 acquires the executed work information by receiving the executed work information, and the processing proceeds to step S13.

In step S13, the information acquisition unit 81 determines whether the acquired state information as the post-work state information of the ecosystem after the work indicated by any piece of executed work information among the executed work information not yet stored in the DB 13 is performed is acquired in the executed work information acquired in step $12.

In a case where it is determined in step S13 that the acquired state information as the post-work state information of the ecosystem after the work indicated by the executed work information is performed is not acquired, the processing returns to step S11, and similar processing is repeated thereafter.

On the other hand, in a case where it is determined in step S13 that the acquired state information as the post-work state information of the ecosystem after the work indicated by the executed work information is performed is acquired, the processing proceeds to step S14.

In step S14, the information acquisition unit 81 stores a data set in which the executed work information is associated with the post-work state information of the ecosystem after the work indicated by the executed work information is performed and the acquired state information as the pre-work state information of the ecosystem when the work is performed (immediately before the work is performed) in the DB 13, and the processing returns to step S11.

First, in step S14, the information acquisition unit 81 acquires, from the executed work information acquired in step S12, the executed work information (t) indicating the work performed immediately before on the ecosystem for which the state is indicated by the post-work state information determined to be acquired in step S13.

Further, the information acquisition unit 81 acquires, from the acquired state information acquired in step S11, the acquired state information as the pre-work state information (t) indicating the state of the ecosystem on which the work indicated by the executed work information (t) is performed when the work is performed, and the acquired state information as the post-work state information (t+1) indicating the state of the ecosystem on which the work is performed after the work is performed.

Then, the information acquisition unit 81 stores a data set in which the executed work information (t), the pre-work state information (t), and the post-work state information (t+1) are associated in the DB 13.

Note that the terminal 11 can transmit the acquired state information to the server 12 together with the position information (including, in addition to the position of the ecosystem, a range (size) as necessary) of the ecosystem for which the state is indicated by the acquired state information. Similarly, the terminal 11 can transmit the executed work information to the server 12 together with the position information of the ecosystem on which the work indicated by the executed work information is performed.

In the server 12, the information acquisition unit 81 can specify the ecosystem for which the state is indicated by the acquired state information and the ecosystem on which the work indicated by the executed work information is performed according to the position information transmitted together with the acquired state information and the executed work information from the terminal 11.

This makes it possible to specify the acquired state information indicating the state of a certain ecosystem and the executed work information indicating the work performed on the ecosystem.

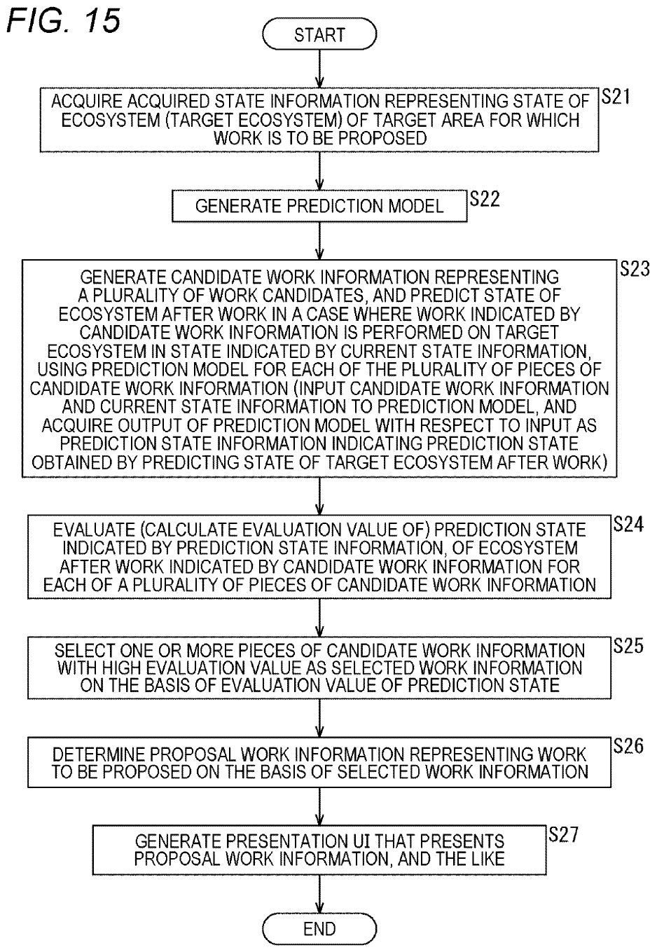

FIG. 15 is a flowchart for explaining an example of processing of the server 12 proposing a work to be performed on the ecosystem.

In step S21, the prediction unit 83 acquires current state information indicating a current state of the ecosystem (target ecosystem) of the target area for which the work (information) is to be proposed from the acquired state information from the information acquisition unit 81, and the processing proceeds to step S22.

In step S22, the prediction model generation unit 82 generates a prediction model using the data sets stored in the DB 13 and supplies the prediction model to the prediction unit 83, and the processing proceeds to step S23.

In step S23, the prediction unit 83 generates candidate work information representing a plurality of work candidates. Further, for each of the plurality of pieces of candidate work information, the prediction unit 83 predicts the state of the target ecosystem after the work in a case where the work indicated by the candidate work information is performed on the target ecosystem for which the state is indicated by the current state information by using the prediction model. In other words, the prediction unit 83 inputs the candidate work information and the current state information to the prediction model for each of the plurality of pieces of candidate work information, and acquires the output of the prediction model with respect to the input as the prediction state information indicating the prediction state obtained by predicting the state of the target ecosystem after the work.

Here, the candidate work information includes information indicating one work (such as a work of seeding a predetermined plant species at a predetermined seeding rate) and information indicating two or more works that can be combined. Examples of the two or more works that can be combined include an arbitrary combination of a work of seeding a predetermined plant species at a predetermined seeding rate, a work of thinning out and harvesting a predetermined plant species at a predetermined thinning harvesting rate, a work of seeding another predetermined plant species at a predetermined seeding rate, a work of thinning out and harvesting another predetermined plant species at a predetermined thinning harvesting rate, and the like.

The prediction unit 83 supplies the prediction state information for each of the plurality of pieces of candidate work information to the evaluation unit 84, and the processing proceeds from step S23 to step S24.

Here, in a case where an update amount (addition amount) of the information (data sets) in the DB 13 from the time of the previous generation is small (for example, in a case where the update amount is equal to or less than a threshold), the prediction model generation processing in step S22 can be skipped. In this case, in step S23, the prediction unit 83 predicts the state of the ecosystem by using the prediction model generated last time.

In step S24, the evaluation unit 84 sets the evaluation method and evaluates the prediction state indicated by the prediction state information of the post-work ecosystem indicated by the candidate work information using the set evaluation method for each of the plurality of pieces of candidate work information. For example, the evaluation unit 84 sets an evaluation calculation formula for calculating the evaluation value according to the purpose information transmitted from the terminal 11 and calculates the evaluation value of the prediction state according to the evaluation calculation formula.

The evaluation unit 84 supplies the evaluation value of the prediction state for each of the plurality of pieces of candidate work information to the work selection unit 85, and the processing proceeds from step S24 to step S25.

In step S25, the work selection unit 85 selects one or more pieces of candidate work information having a high evaluation value as the selected work information according to the evaluation value of the prediction state for each of the plurality of pieces of candidate work information and supplies the selected work information to the work determination unit 86, and the processing proceeds to step S26.

In step S26, the work determination unit 86 determines proposal work information indicating the work to be proposed according to the selected work information from the work selection unit 85 and supplies the proposal work information to the generation unit 87, and the processing proceeds to step S27.

In step S27, the generation unit 87 generates a presentation UI that presents the proposal work information, and the like, from the work determination unit 86 and transmits the presentation UI to the terminal 11, and the processing ends.

As described above, in the server 12, the state of the post-work ecosystem in a case where the work indicated by the candidate work information is performed on the target ecosystem is predicted using the current state information of the target ecosystem, the predicted state of the target ecosystem is evaluated, and the proposal work information is determined according to the evaluation result. Thus, for example, by evaluating the predicted state of the target ecosystem using the evaluation method according to the extended ecosystem aimed by the user or the purpose of constructing the extended ecosystem, it is possible to propose an appropriate work for modifying the target ecosystem in an arbitrary state into the target extended ecosystem, or the like.

Furthermore, by actually performing the proposed work, it is possible to collect a data set in which the executed work information indicating the actually performed work, the post-work state information of the ecosystem after the work indicated by the executed work information is performed, and the pre-work state information of the ecosystem when the work is performed are associated.

Note that the server 12 can predict the state of the target ecosystem in a more future by repeatedly predicting the state of the target ecosystem. For example, in the server 12, the prediction state of the post-work ecosystem in a case where the work indicated by each of the plurality of pieces of candidate work information is performed on the target ecosystem is predicted using the current state information of the target ecosystem, and after the prediction state is evaluated, one piece of candidate work information, for example, the prediction state information of the post-work ecosystem in a case where the work indicated by the candidate work information having the highest evaluation value of the prediction state is performed on the target ecosystem can be obtained as the state information of the future ecosystem at a time point one time-unit ahead. Further, the server 12 predicts the prediction state of the post-work ecosystem in a case where the work indicated by each of the plurality of pieces of candidate work information is performed on the target ecosystem again using the state information of the future ecosystem at a time point one time-unit ahead, evaluates the prediction state, and then, can obtain one candidate work information, for example, the prediction state information of the post-work ecosystem in a case where the work indicated by the candidate work information having the highest evaluation value of the prediction state is performed on the target ecosystem as the state information of the future ecosystem at a time point two time-units ahead. In the server 12, it is possible to obtain the state information of the future ecosystem in a similar manner.

### Examples of State Information and Work Information

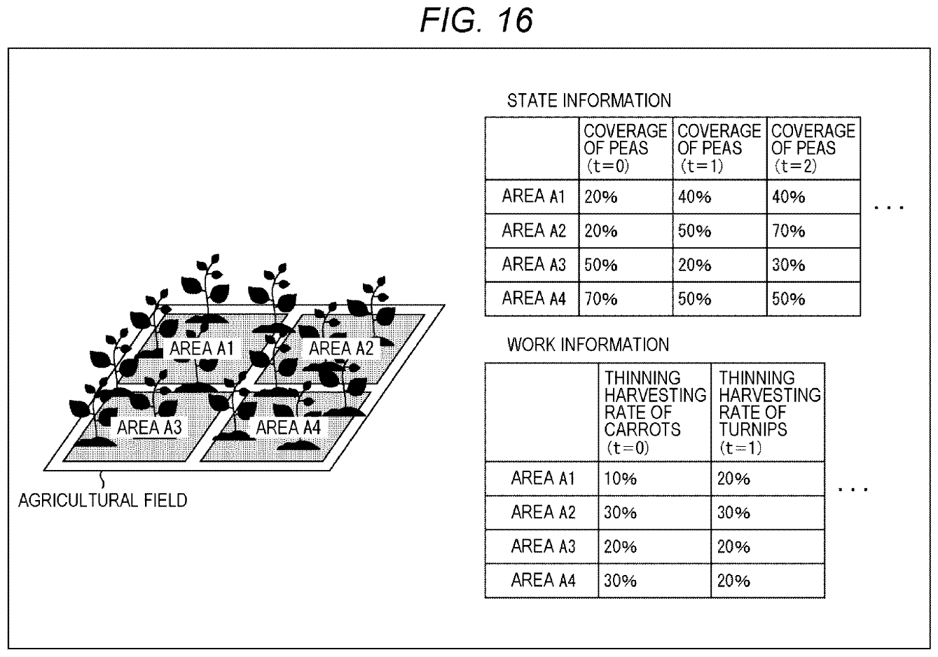

FIG. 16 is a view illustrating an example of the state information and the work information.

In FIG. 16, the agricultural field includes four areas A1, A2, A3, and A4, and the state information of each of the ecosystems of the four areas A1 to A4 and the (proposal) work information proposed to the ecosystem are illustrated in time series.

As described above, the entire agricultural field can be divided into a plurality of areas, and the (proposal) work information can be proposed to the ecosystem of each area, instead of forming the entire agricultural field into one area. In this case, the proposal work information can have variations.

In a case where the agricultural field is divided into a plurality of areas, (some or all of) the work devices arranged in the agricultural field can be shared in some or all of the areas, or a dedicated work device can be arranged in each area, for the work device 22 that performs a work in each area.

In FIG. 16, a coverage of peas is illustrated as the state information of the ecosystem. In the ecosystem of the area A1, the coverages of the peas at the time point t=0, 1, 2, . . . are 20%, 40%, 40%, . . . , respectively, and in the ecosystem of the area A2, the coverages of the peas at the time point t=0, 1, 2, . . . are 20%, 50%, 70%, . . . . respectively. In the ecosystem of the area A3, the coverages of the peas at the time point t=0, 1, 2, . . . are 50%, 20%, 30%, . . . , respectively, and in the ecosystem of the area A4, the coverages of the peas at the time point t=0, 1, 2, . . . are 70%, 50%, 50%, . . . , respectively.

In FIG. 16, for the ecosystem of the area A1, work information for performing thinning harvesting of carrots at a thinning harvesting rate of 10%, work information for performing thinning harvesting of turnips at a thinning harvesting rate of 20%, and . . . are proposed at time points t=0, 1, respectively. For the ecosystem in the area A2, work information for performing thinning harvesting of carrots at a thinning harvesting rate of 30%, work information for performing thinning harvesting of turnips at a thinning harvesting rate of 30%, and . . . are proposed at time points t=0, 1, . . . , respectively. For the ecosystem in the area A3, work information for performing thinning harvesting of carrots at a thinning harvesting rate of 20%, work information for performing thinning harvesting of turnips at a thinning harvesting rate of 20%, and . . . are proposed at time points t=0, 1, . . . , respectively. For the ecosystem in the area A4, work information for performing thinning harvesting of carrots at a thinning harvesting rate of 30%, work information for performing thinning harvesting of turnips at a thinning harvesting rate of 20%, and . . . proposed at time points t=0, 1, . . . respectively.

Note that FIG. 16 indicates that, for example, in the area A1, the coverage of peas is 20% at the time point t=0, and as a result of performing thinning harvesting of carrots at a thinning harvesting rate of 10%, the coverage of peas is 40% at the next time point t=1.

In this case, a fact that the coverage of the peas at the time point t=0 is 20% corresponds to the pre-work state information, and performing thinning harvesting of carrots at the thinning harvesting rate of 10% at the time point t=0 corresponds to the executed work information.

Further, a fact that the coverage of the peas at the time point t=1 is 40% corresponds to the post-work state information.

Further, FIG. 16 indicates that, for example, in the area A1, the coverage of peas is 40% at the time point t=1, and as a result of performing thinning harvesting of turnips at the thinning harvesting rate of 20%, the coverage of peas is 40% at the next time point t=2.

In this case, a fact that the coverage of peas at the time point t=1 is 40% corresponds to the pre-work state information, and performing thinning harvesting of turnips at the thinning harvesting rate of 20% at the time point t=1 corresponds to the executed work information. Further, a fact that the coverage of peas at the time point t=2 is 40% corresponds to the post-work state information.

This similarly applies to the other areas A2 to A4 in the above points.

### Second Functional Configuration Example of Server 12

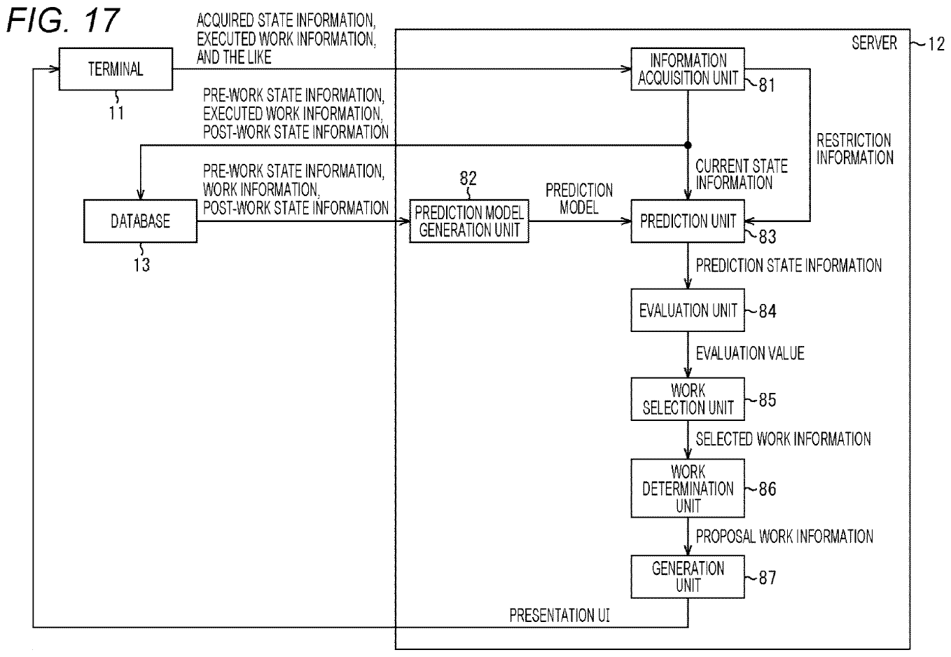

FIG. 17 is a block diagram illustrating a second functional configuration example of the server 12.

Note that, in the drawing, portions corresponding to those in the case of FIG. 8 are denoted by the same reference numerals, and the description thereof will be appropriately omitted below.

In FIG. 17, the server 12 includes an information acquisition unit 81 to a generation unit 87.

Thus, the server 12 of FIG. 17 is common to the case of FIG. 8 in including the information acquisition unit 81 to the generation unit 87. However, the server 12 of FIG. 17 is different from the case of FIG. 8 in which restriction information is not supplied from the information acquisition unit 81 to the prediction unit 83.

The restriction information is information for restricting the candidate work information for which the prediction unit 83 is to predict the prediction state, and can be input by the user operating the terminal 11 and can be transmitted from the terminal 11 to the server 12, for example. The information acquisition unit 81 can acquire the restriction information from the terminal 11 by receiving the restriction information and can supply the restriction information to the prediction unit 83.

The prediction unit 83 can restrict the candidate work information for which the prediction state is to be predicted according to the restriction information from the information acquisition unit 81 and predict the prediction state of the target ecosystem for each piece of the candidate work information remaining after the restriction by the restriction information.

As described with reference to FIG. 8, the prediction unit 83 generates a plurality of pieces of candidate work information by setting one or more types of work parameters for each of a plurality of types of works determined in advance, for example, thinning harvesting, seeding, watering, and the like.

Thus, the number of pieces of candidate work information may be enormous depending on the number of plant species to be subjected to thinning harvesting or seeding and the way of setting work parameters such as a thinning harvesting rate. In a case where the prediction state is predicted for each of the enormous number of pieces of candidate work information, the calculation load increases. Note that the calculation load of the prediction of the prediction state increases even if the number of elements of the state of the ecosystem indicated by the state information increases.

Thus, the prediction unit 83 reduces the number of pieces of candidate work information by restricting the candidate work information according to the restriction information. This makes it possible to reduce the calculation load of prediction of the prediction state.

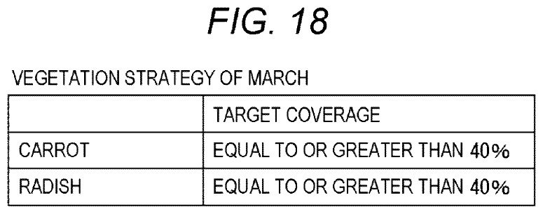

FIG. 18 is a view indicating an example of the restriction information.

As the restriction information, for example, a vegetation strategy set for the target ecosystem can be adopted.

In FIG. 18, a vegetation strategy in which the coverages of carrots and radishes are both made equal to or greater than 40% is set for the target ecosystem.

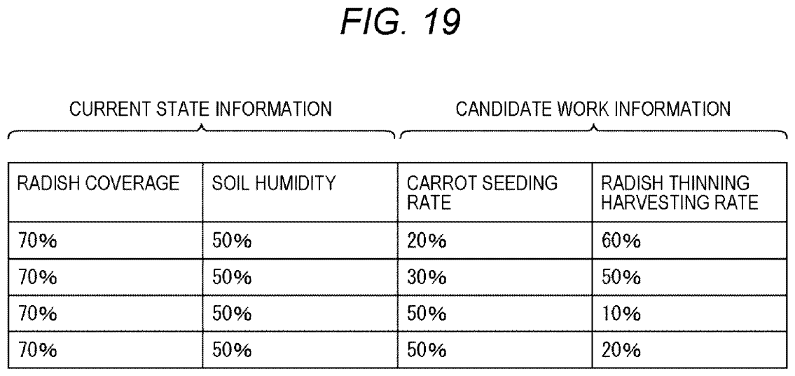

FIG. 19 is a view indicating an example of the current state information and the candidate work information.

In FIG. 19, the coverage of radishes and the humidity of soil are indicated as the current state information indicating the state of the target ecosystem. The coverage of radishes and the humidity of soil as the current state information are 70% and 50%, respectively. Hereinafter, such state information is also referred to as a radish coverage of 70%, a soil humidity of 50%, and the like.

For example, a radish coverage of 70% means that the area where the work is to be performed is covered with radishes at a coverage of 70% of the entire area.

FIG. 19 indicates that, as the candidate work information indicating the work to be performed on the target ecosystem, seeding of carrots and thinning harvesting of radishes are performed at a seeding rate of 20% and a thinning harvesting rate of 60%, respectively, performed at the seeding rate of 30% and the thinning harvesting rate of 50%, performed at the seeding rate of 50% and the thinning harvesting rate of 10%, and performed at the seeding rate of 50% and the thinning harvesting rate of 20%. Hereinafter, such work information is also referred to as a carrot seeding rate of 20%, a radish thinning harvesting rate of 60%, and the like. Seeding of carrots and thinning harvesting of radishes are types of works, and a seeding rate of 50% and a thinning harvesting rate of 20% are work parameters.

For example, a carrot seeding rate of 20% means that the carrots are seeded in 20% of the area of the entire area where the seeding work is to be performed. In addition, for example, a radish thinning harvesting rate of 60% means that (thinning) harvesting of radishes is performed in 60% of the entire area covered by radishes where the work of thinning harvesting of radishes is to be performed.

It is assumed that four pieces of work information indicated in FIG. 19, that is, performing seeding of carrots and thinning harvesting of radishes at a seeding rate of 20% and a thinning harvesting rate of 60%, respectively, at the seeding rate of 30% and the thinning harvesting rate of 50%, at the seeding rate of 50% and the thinning harvesting rate of 10%, and at the seeding rate of 50% and the thinning harvesting rate of 20%, are, for example, candidate work information.

For each of the four pieces of candidate work information, the prediction unit 83 predicts the state of the target ecosystem after the work in a case where the work indicated by the candidate work information is performed on the target ecosystem indicated by the current state information. In other words, for each of the four pieces of candidate work information, the prediction unit 83 inputs a set of the current state information and the candidate work information to the prediction model as explanatory variables and acquires an objective variable which is an output of the prediction model for the inputs as prediction state information indicating a prediction state obtained by predicting the state of the target ecosystem after the work.

However, in a case where the restriction information is supplied, the prediction unit 83 restricts the candidate work information to be used for prediction according to the restriction information and predicts the state of the target ecosystem after the work only for the restricted candidate work information.

For example, as illustrated in FIG. 18, in a case where a vegetation strategy in which the coverages of carrots and radishes are both made equal to or greater than 40% is supplied as the restriction information, the candidate work information to be used for prediction is restricted to candidate work information that does not inhibit (can achieve) the vegetation strategy in which the coverages of carrots and radishes are both made equal to or greater than 40%.

Among the four pieces of candidate work information in FIG. 19, the candidate work information that does not inhibit the vegetation strategy in which the coverages of carrots and radishes are both made equal to or greater than 40% in the target ecosystem for which the state is indicated by the current state information is two pieces of candidate work information of the carrot seeding rate of 50% and the radish thinning harvesting rate of 10% in the second row from the bottom and the carrot seeding rate of 50% and the radish thinning harvesting rate of 20% in the lowermost row, and thus, the candidate work information to be used for prediction is restricted to the two pieces of candidate work information.

As described above, by restricting the candidate work information to be used for prediction according to the restriction information, it is possible to reduce the number of pieces of candidate work information to be used for prediction and reduce the amount of calculation.

Note that, as the restriction information, information other than the vegetation strategy, for example, information regarding an ecosystem function (ecosystem service) desired by the user, or the like, can be adopted. For example, in a case where the restriction information is information indicating that an intestinal regulation function is desired as the ecosystem function, the prediction unit 83 can restrict the candidate work information such that the coverage of the plant species symbiotic with the microbial species having the function of the intestinal regulation function becomes equal to or more than a predetermined value.

### Third Functional Configuration Example of Server 12

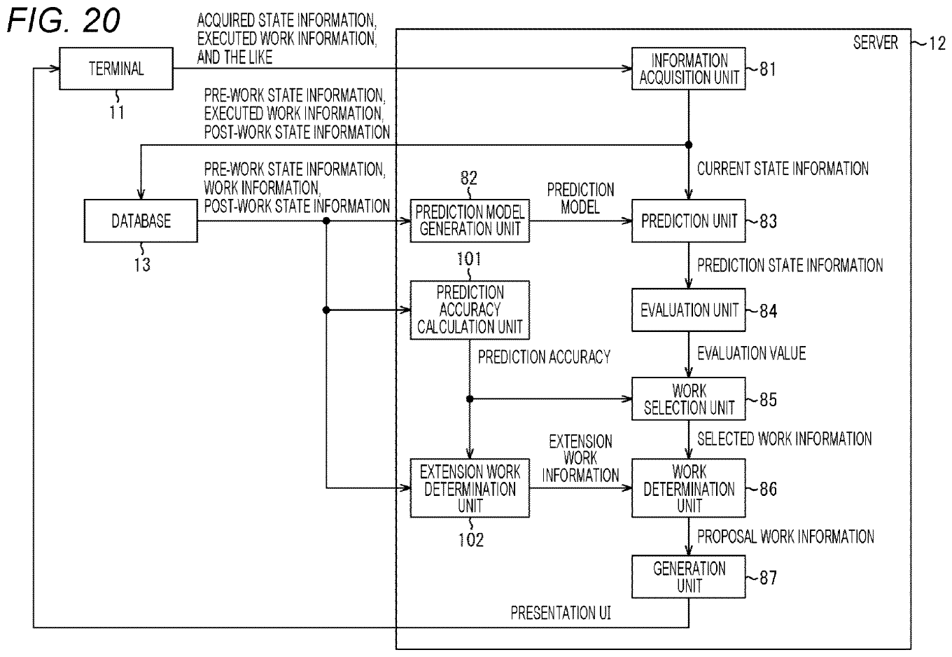

FIG. 20 is a block diagram illustrating a third functional configuration example of the server 12.

Note that, in the drawing, portions corresponding to those in the case of FIG. 8 are denoted by the same reference numerals, and the description thereof will be appropriately omitted below.

In FIG. 20, the server 12 includes the information acquisition unit 81 to the generation unit 87, a prediction accuracy calculation unit 101, and an extension work determination unit 102.

Thus, the server 12 of FIG. 20 is common to the case of FIG. 8 in including the information acquisition unit 81 to the generation unit 87. However, the server 12 of FIG. 20 is different from the case of FIG. 8 in that the prediction accuracy calculation unit 101 and the extension work determination unit 102 are newly provided.

For each of the plurality of pieces of candidate work information, the prediction accuracy calculation unit 101 calculates prediction accuracy of the prediction state indicated by the prediction state information output by the prediction model in a case where the state of the ecosystem is predicted using the candidate work information as an input of the prediction model.

As the prediction accuracy of the prediction state, for example, in the DB space (FIG. 9), a coverage of the data set points in the vicinity of the data set point in which the candidate work information and the current state information input to the prediction model are set as values of the work axis and the pre-work state axis can be adopted.

Here, the work axis, the pre-work state axis, and the post-work state axis of the DB space are an x axis, a y axis, and a z axis, respectively, and the data set point is represented by coordinates (x, y, z). In addition, the values of the work axis and the pre-work state axis of the candidate work information and the current state information input to the prediction model are represented as x0 and y0, respectively. As the neighboring partial space, for example, a columnar space having a predetermined radius r centered around a point on a straight line (x0, y0, z) in the DB space can be adopted.

The coverage of the data set points in the neighboring partial space represents a degree to which the data set points are uniformly distributed in the neighboring partial space. As the coverage, for example, goodness of fit of the data set points in the neighboring partial space with respect to a uniform distribution that is applicable to the data set points in the neighboring partial space can be adopted. The uniform distribution applicable to the data set points in the neighboring partial space can be calculated by, for example, a maximum likelihood estimation method, or the like. For example, the sum of squares of residuals between the uniform distribution and the data set points in the neighboring partial space can be adopted as the goodness of fit of the data set points in the neighboring partial space with respect to the uniform distribution.

The prediction accuracy calculation unit 101 refers to the DB 13, calculates the prediction accuracy of the prediction state for each of the plurality of pieces of candidate work information as described above, and supplies the prediction accuracy to the work selection unit 85 and the extension work determination unit 102.

In FIG. 20, the work selection unit 85 selects the selected work information from the plurality of pieces of candidate work information according to the prediction accuracy of the prediction state from the prediction accuracy calculation unit 101 in addition to the evaluation value from the evaluation unit 84. For example, it is possible to select, as the selected work information, one piece of candidate work information having the highest product or sum of the evaluation value and the prediction accuracy or N (top N) pieces of candidate work information having the highest product or sum of the evaluation value and the prediction accuracy.

As described above, by selecting the selected work information from the plurality of pieces of candidate work information according to the evaluation value and the prediction accuracy, it is possible to suppress the candidate work information for which prediction accuracy of the prediction state is predicted to be poor from becoming the selected work information and eventually the proposal work information.

Here, in FIG. 20, the work determination unit 86 determines the proposal work information by using the selected work information selected according to the evaluation value and the prediction accuracy, so that it can be said that the proposal work information is determined according to the evaluation value and the prediction accuracy.

The extension work determination unit 102 determines extension work information that is work information for extending the DB 13 according to the prediction accuracy from the prediction accuracy calculation unit 101. For example, the extension work determination unit 102 refers to the DB 13 and specifies, in the DB space, a partial space in the vicinity of a data set point having candidate work information and current state information with low prediction accuracy as values of the work axis and the pre-work state axis, respectively. The extension work determination unit 102 can determine the work information indicated by randomly selected points in the partial space as the extension work information for extending the DB 13.

In addition, for example, the extension work determination unit 102 can determine, as the extension work information, work information represented by points randomly selected from points in a partial space in which data set points are coarse in the DB space.

The extension work determination unit 102 supplies the extension work information to the work determination unit 86.

In FIG. 20, as in the case of FIG. 8, the work determination unit 86 determines the evaluation improvement work information according to the selected work information from the work selection unit 85 and determines the evaluation improvement work information as the proposal work information. Further, the work determination unit 86 determines all or part of the extension work information from the extension work determination unit 102 as the proposal work information.

The work determination unit 86 divides the target area into sub-areas as necessary. As described with reference to FIGS. 12 and 13, the work determination unit 86 assigns the evaluation improvement work information and the extension work information determined as the proposal work information to the sub-areas of the target area in accordance with the extension ratio, includes information regarding the assignment of the proposal work information, and supplies the information to the generation unit 87.

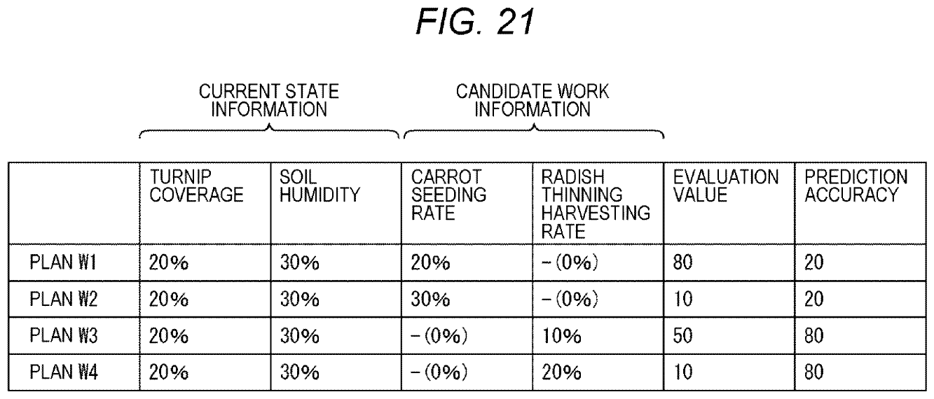

FIG. 21 is a view indicating an example of the evaluation values and the prediction accuracy obtained for the candidate work information.

FIG. 21 indicates an example of the evaluation values and the prediction accuracy obtained for four pieces of candidate work information of a carrot seeding rate of 20% and a radish thinning harvesting rate of 0%, a carrot seeding rate of 30% and a radish thinning harvesting rate of 0%, a carrot seeding rate of 0% and a radish thinning harvesting rate of 10%, and a carrot seeding rate of 0% and a radish thinning harvesting rate of 20% in a case where the current state information is a turnip coverage rate of 20% and a soil humidity of 30%. A radish thinning harvesting rate of 0% is equivalent to no radish thinning harvesting. A carrot seeding rate of 0% is equivalent to no carrot seeding.

Here, it can be said that the set of (current) state information and (candidate) work information is a plan for performing the work indicated by the work information on the ecosystem in the state indicated by the state information. Thus, a set of the state information and the work information is also referred to as a plan.

FIG. 21 indicates four plans W1 to W4 including a plan W1 for performing a work at a carrot seeding rate of 20% and a radish thinning harvesting rate of 0%, a plan W2 for performing a work at a carrot seeding rate of 30% and a radish thinning harvesting rate of 0%, a plan W3 for performing a work at a carrot seeding rate of 0% and a radish thinning harvesting rate of 10%, and a plan W4 for performing a work at a carrot seeding rate of 0% and a radish thinning harvesting rate of 20% in an ecosystem with a turnip coverage rate of 20% and a soil humidity of 30%.

For the candidate work information representing the works to be performed in the plans W1 to W4 , 80, 10, 50, and 10 are calculated as the evaluation values, and 20, 20, 80, and 80 are calculated as the prediction accuracy, respectively. Note that a greater evaluation value indicates higher evaluation. Similarly, a greater value of the prediction accuracy indicates higher accuracy.

In a case where the work selection unit 85 selects the selected work information from the candidate work information only in accordance with the evaluation value, for example, the candidate work information indicating the work of the plan W1 having the highest evaluation value of 80 is selected as the selected work information.

In a case where the work selection unit 85 selects the selected work information from the candidate work information according to the evaluation value and the prediction accuracy, for example, the candidate work information representing the work of the plan W3 having the largest product of the evaluation value and the prediction accuracy is selected as the selected work information.

In FIG. 21, the distribution of the data set points is coarse (the coverage is low) in the neighboring partial space SS in the vicinity of the data set point at which the turnip coverage of 20% and the soil humidity of 30% are set as the values of the pre-work state axis and the carrot seeding rates of 20% to 30% are set as the values of the work axis. Thus, the prediction accuracy is a low value of 20 for the candidate work information of plans W1 and W2 in which the work is performed at the carrot seeding rates of 20% and 30%, respectively.

On the other hand, in the neighboring partial space SS′ in the vicinity of the data set point at which the turnip coverage of 20% and the soil humidity of 30% are set as the values of the pre-work state axis and the radish thinning harvesting rates of 10% to 20% are set as the values of the work axis, the distribution of the data set points is dense (the coverage is high). For example, in the neighboring partial space SS′, there are 10 times as many data set points as the neighboring partial space SS. Thus, the prediction accuracy is a high value of 80 for the candidate work information of each of plans W3 and W4 in which the work is performed at the radish thinning harvesting rates of 10% and 20%.

In FIG. 21, for the candidate work information of the plans W1 and W2 , in order to eliminate the cause of the low prediction accuracy of 20, that is, the coarse distribution of the data set points in the neighboring partial space SS, the extension work determination unit 102 can determine the work information represented by randomly selected points in the neighboring partial space SS as the extension workinformation.

In this case, the extension work information is work information indicating seeding of carrots at the seeding rate of 20% to 30%. By performing the work indicated by the extension work information, the data set in which the distribution of the data set points fills the coarse neighboring partial space SS is collected in the DB space, and the DB 13 can be extended.

In a case where the plurality of pieces of candidate work information is (finally) determined as the proposal work information in the work determination unit 86, that is, in a case where the plurality of pieces of candidate work information is selected as the selected work information in the work selection unit 85 and (the candidate work information selected as) the plurality of pieces of selected work information is determined as the proposal work information in the work determination unit 86, the work determination unit 86 can assign each of the plurality of pieces of proposal work information to a sub-area having a size (ratio) corresponding to the evaluation result (evaluation value) of the prediction state for the candidate work information determined as the proposal work information.

For example, in a case where the candidate work information of the four plans W1 to W4 indicated in FIG. 21 is determined as the proposal work information, the work determination unit 86 can assign the candidate work information of the plans W1 to W4 determined as the proposal work information to the sub-areas having sizes corresponding to the evaluation values 80, 10, 50, and 10 of the prediction states of the candidate work information of the plans W1 to W4 , respectively. In this case, for example, if the target area is divided (equally divided) into 150 sub-areas, the candidate work information of the plans W1 to W4 determined as the proposal work information is assigned to the sub-areas at a ratio of 80:10: 50: 10, that is, 80, 10, 50, and 10 sub-areas, respectively.

In a case where the prediction accuracy of the prediction state is calculated for the plurality of pieces of candidate work information, the work determination unit 86 can assign each of the plurality of pieces of proposal work information to a sub-area having a size corresponding to the evaluation value of the prediction state and the prediction accuracy for the candidate work information determined as the proposal work information.

For example, in a case where the candidate work information of the four plans W1 to W4 indicated in FIG. 21 is determined as the proposal work information, the work determination unit 86 can assign the candidate work information of the plans W1 to W4 determined as the proposal work information to the sub-areas having sizes corresponding to the evaluation values 80, 10, 50, and 10 of the prediction states and the prediction accuracies 20, 20, 80, and 80 for the candidate work information of the plans W1 to W4 . In this case, for example, if the target area is divided into 33 sub-areas, the candidate work information of the plans W1 to W4 determined as the proposal work information is assigned to sub-areas at a ratio of 80×20:10×20:50×80:10×80=8:1: 20:4, that is, 8, 1, 20, and 4 sub-areas, respectively.

As described above, in the assignment of the proposal work information, the proposal work information is assigned to sub-areas in the prediction states of the candidate work information determined as the proposal work information, that is, having the evaluation values of the prediction states of the target ecosystem in a case where the work indicated by the proposal work information is performed, or having sizes (number) according to the prediction accuracy. It is therefore possible to secure variations (combinations) of works as a portfolio prepared for a case where the state of the target ecosystem in a case where the work indicated by the proposal work information is performed becomes a state different from the prediction due to an unexpected factor while keeping a high possibility of causing the state of the target ecosystem to reach the state of the target extended ecosystem.

### Fourth Functional Configuration Example of Server 12

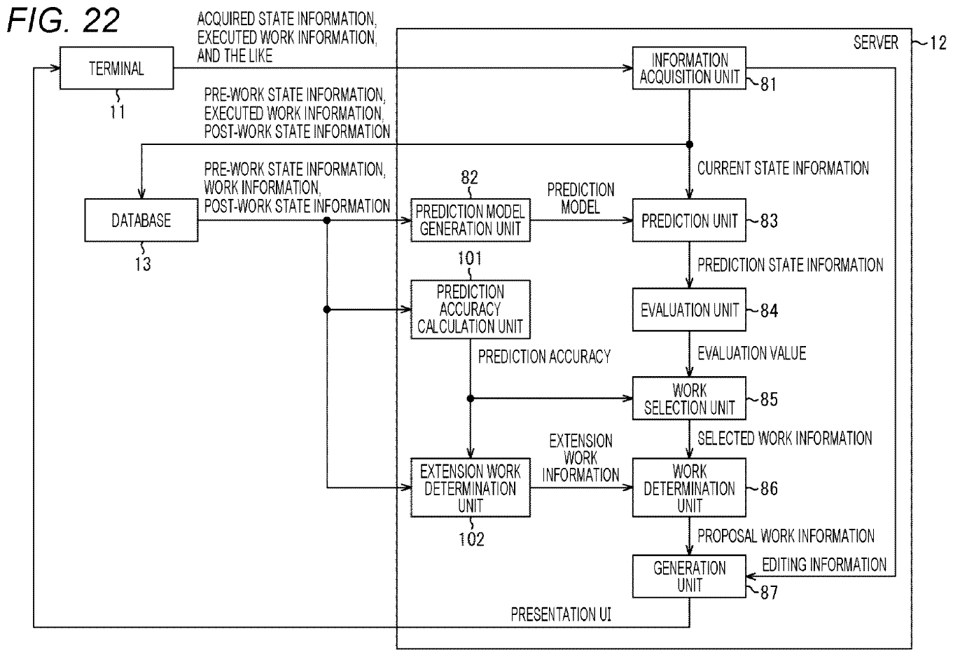

FIG. 22 is a block diagram illustrating a fourth functional configuration example of the server 12.

Note that, in the drawing, portions corresponding to those in the case of FIG. 20 are denoted by the same reference signs, and the description thereof will be appropriately omitted below.

In FIG. 22, the server 12 includes the information acquisition unit 81 to the generation unit 87, the prediction accuracy calculation unit 101, and the extension work determination unit 102.

Thus, the server 12 of FIG. 22 is common to the case of FIG. 20 in including the information acquisition unit 81 to the generation unit 87, the prediction accuracy calculation unit 101, and the extension work determination unit 102. However, the server 12 of FIG. 22 is different from the case of FIG. 20 in which editing information is not supplied from the information acquisition unit 81 to the generation unit 87.

The terminal 11 receives and displays the presentation UI that presents the proposal work information, and the like, transmitted from the server 12. The user views the presentation UI displayed on the terminal 11, and if necessary, operates the terminal 11 to input editing information for editing the proposal work information, and the like, included in the presentation UI.

The terminal 11 transmits the editing information to the server 12. In the server 12, the information acquisition unit 81 receives the editing information from the terminal 11 and supplies the editing information to the generation unit 87.

The generation unit 87 edits the presentation UI according to the editing information from the information acquisition unit 81 and transmits the edited presentation UI to the terminal 11.

The terminal 11 receives and displays the presentation UI from the generation unit 87. As a result, the terminal 11 displays the edited presentation UI, for example, the presentation UI in which correction (change), deletion, or addition is made in the proposal work information according to the editing information (information from the user).

As described above, the user can edit the proposal work information, and the like, of the presentation UI.

Thus, for example, the skilled user can edit the proposal work information of the presentation UI to the proposal work information indicating the work considered to be appropriate for construction of the target extended ecosystem in experience, and reflect his/her empirical rule in the presentation UI.

### Fifth Functional Configuration Example of Server 12

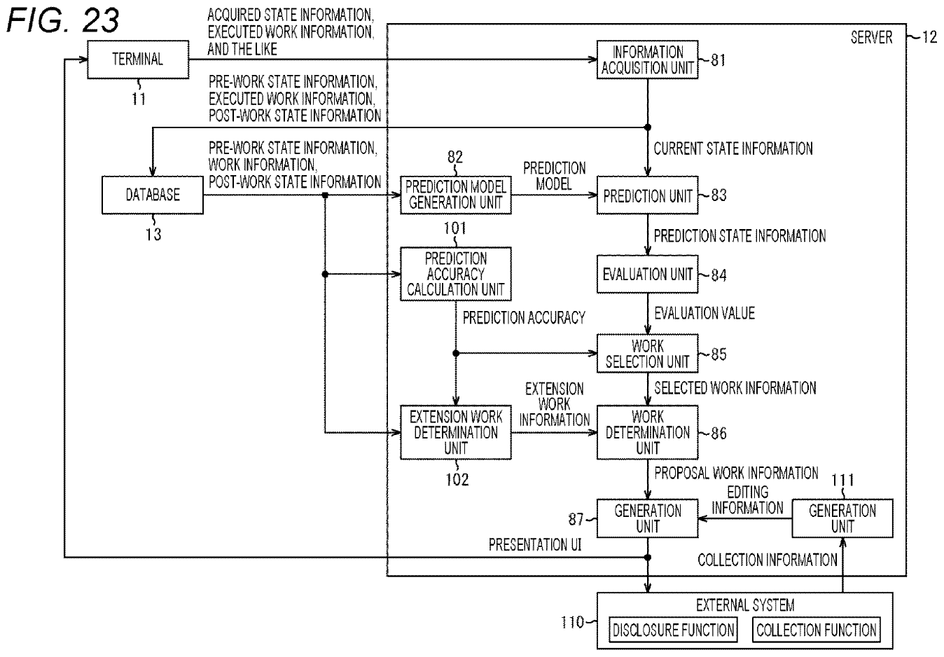

FIG. 23 is a block diagram illustrating a fifth functional configuration example of the server 12.

Note that, in the drawing, portions corresponding to those in the case of FIG. 20 are denoted by the same reference signs, and the description thereof will be appropriately omitted below.

In FIG. 23, the server 12 includes the information acquisition unit 81 to the generation unit 87, the prediction accuracy calculation unit 101, the extension work determination unit 102, and a generation unit 111.

Thus, the server 12 of FIG. 23 is common to the case of FIG. 20 in including the information acquisition unit 81 to the generation unit 87, the prediction accuracy calculation unit 101, and the extension work determination unit 102. However, the server 12 of FIG. 23 is different from the case of FIG. 20 in that the generation unit 111 is newly provided.

In FIG. 23, the generation unit 87 transmits the presentation UI including the proposal work information, and the like, to an external system 110.

The external system 110 is a platform such as a dedicated social networking service (SNS) in which an unspecified number of users or a plurality of specific users who have become members can access the presentation UI and exchange information regarding (the content of) the presentation UI via the Internet, or the like. The external system 110 has a disclosure function of disclosing the presentation UI to an arbitrary or specific user, and a collection function of collecting posts on the presentation UI from the user who has browsed the presentation UI.

The external system 110 discloses the presentation UI from the generation unit 87 by, for example, SNS. The user who has browsed the presentation UI disclosed in the SNS can post an opinion, or the like, to the presentation UI, for example, post a correction proposal, or the like, for correcting the proposal work information included in the presentation UI to the SNS as necessary.

The external system 110 collects the posts to the SNS for each area and transmits the posts collected for each area to the generation unit 111 as collection information.

The generation unit 111 generates editing information for editing the proposal work information, and the like, included in the presentation UI for the target area from the collection information of the target area among the collection information for each area from the external system 110 and supplies the editing information to the generation unit 87.

For example, the generation unit 111 generates the editing information by performing statistical processing, or the like, of a plurality of posts of the correction proposal for correcting the proposal work information as the collection information of the target area. For example, in a case where there is a plurality of posts of the correction proposal for correcting the proposal work information indicating the work to be performed in the same period in (the ecosystem of) the target area, the generation unit 111 generates an average of the plurality of posts as the editing information. Specifically, for example, in a case where there is a post of the correction proposal for correcting the proposal work information indicating the work of seeding carrots to be performed in the target area in April, the correction proposal for seeding carrots at a frequency of once a week, three times a week, and five times a week from three users, editing information indicating that the work of seeding carrots is performed at a frequency of three times a week obtained by averaging the frequencies is generated.

Note that, for example, the generation unit 111 can set voting of the correction with the largest number as the editing information by voting, that is, majority voting.

The generation unit 87 edits the presentation UI according to the editing information from the generation unit 111 and transmits the edited presentation UI to the terminal 11.

The terminal 11 receives and displays the presentation UI from the generation unit 87. As a result, the terminal 11 displays the presentation UI after editing, for example, the presentation UI in which the proposal work information is corrected, or the like, according to the editing information (information (posts) from a plurality of users).

As described above, the proposal work information, and the like, of the presentation UI can be edited in accordance with posts of a large number of users. Thus, the empirical rules and collective intelligence of a large number of users can be reflected in (the proposal work information of) the presentation UI.

### Presentation UI

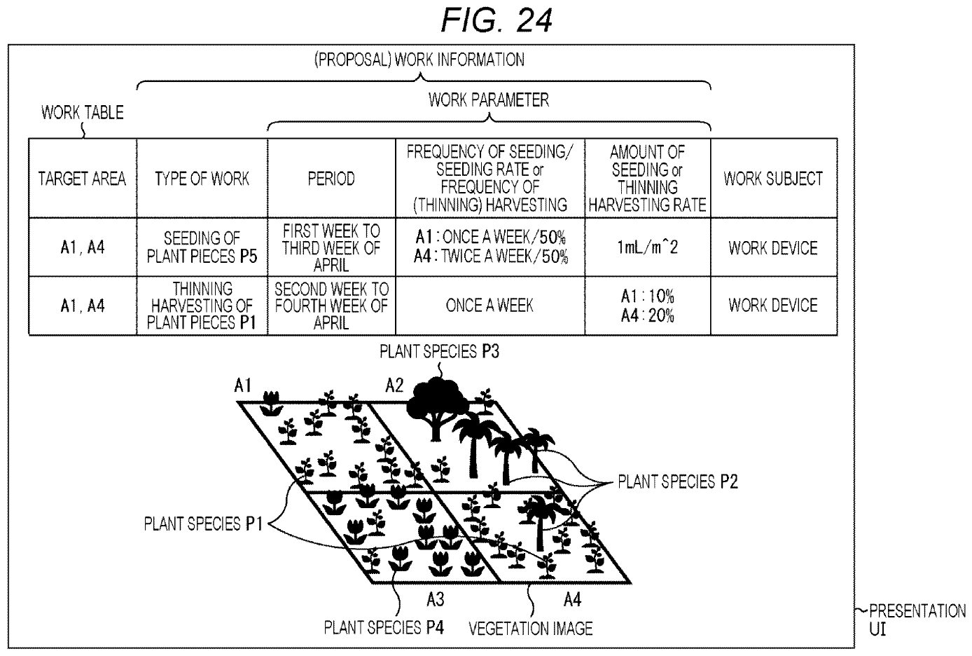

FIG. 24 is a view illustrating a first display example of the presentation UI.

The presentation UI in FIG. 24 includes a work table and a vegetation image and presents the work table and the vegetation image.

The work table is a table in which information regarding works to be performed in (the ecosystem of) the target area is described. In FIG. 24, the work table includes proposal work information and a work subject who is to perform the work indicated by the proposal work information. Further, in FIG. 24, the proposal work information is assigned to the sub-areas, and the work table also includes information regarding the sub-areas to which the proposal work information is assigned.

In FIG. 24, the target area is divided into four sub-areas A1, A2, A3, and A4. In the sub-areas A1 and A4, the proposal work information indicating the work of seeding plant species P5 and the proposal work information indicating thinning harvesting of plant species P1 are assigned. No proposal work information is assigned to the sub-areas A2 and A3.

The proposal work information indicating the work of seeding the plant species P5 includes a period, a frequency, and a seeding rate, and an amount of seeding as the work parameters. The period of seeding is from the first week to the third week of April. The frequency of seeding and the seeding rate are once a week and 50%, respectively, for the sub-area A1, and are twice a week and 50%, respectively, for the sub-area A4. The amount of seeding is 1 mL/m\hat{ }2.

The work subject of the work of seeding the plant species P5 is a work device 22 such as a robot arm.

The proposal work information indicating the work of the thinning harvesting of the plant species P1 includes a period, a frequency, and a thinning harvesting rate of the thinning harvesting as the work parameters. The period of thinning harvesting is from the second week to the fourth week of April. The frequency of the thinning harvesting is once a week. The thinning harvest rate is 10% for the sub-area A1 and 20% for the sub-area A4.

The work subject of the work of thinning harvesting of the plant species P1 is the work device 22 such as a robot arm.

In the presentation UI of FIG. 24, the vegetation image is a two-dimensional (2D) or 3D image in which the vegetation of the ecosystem (target ecosystem) of the target area in which the work indicated by the proposal work information is to be performed is captured. In the vegetation image, the plant species of the vegetation can be displayed as a plant species image in which the plant species are deformed so that the vegetation state of the target ecosystem can be easily understood. In FIG. 24, a plant species image in which the plant species P1, P2, P3, and P4 are deformed is displayed.

In a case where the state information includes the coverage of the plant species or the number of individuals, the plant species image can be displayed in the number or the size corresponding to the coverage of the plant species represented by the plant species image or the number of individuals. In a case where the state information includes a position where the plant species are growing, the plant species image can be displayed in an arrangement corresponding to the position where the plant species represented by the plant species image are growing. In a case where a growth degree of the plant species is included in the state information, the plant species image can be displayed in a size corresponding to the growth degree of the plant species represented by the plant species image.

As described above, by displaying the plant species image in the vegetation image, the user can grasp the coverage of the plant species indicated by the plant species image, the number of individuals, the position where the plant species are growing, and the approximate growth degree by viewing the vegetation image.

For example, in a case where the terminal 11 is a smart glass, a smartphone, or the like, and the user is in the vicinity of the target area, in the terminal 11, the vegetation image can be displayed in augmented reality (AR) in a manner superimposed on the target area in the real world or the target area in the image obtained by capturing the real world. In the AR display, the vegetation image is displayed so as to be superimposed on the target area according to the position information of the terminal 11 and the target area and the posture (orientation) of the terminal 11.

In addition, the vegetation image can be displayed in virtual reality (VR) using a head mount display (HMD) or can be displayed in 2D or 3D on a PC screen.

The proposal work information, and the like, included in the work table of the presentation UI can be edited according to operation by the user as described with reference to FIG. 22.

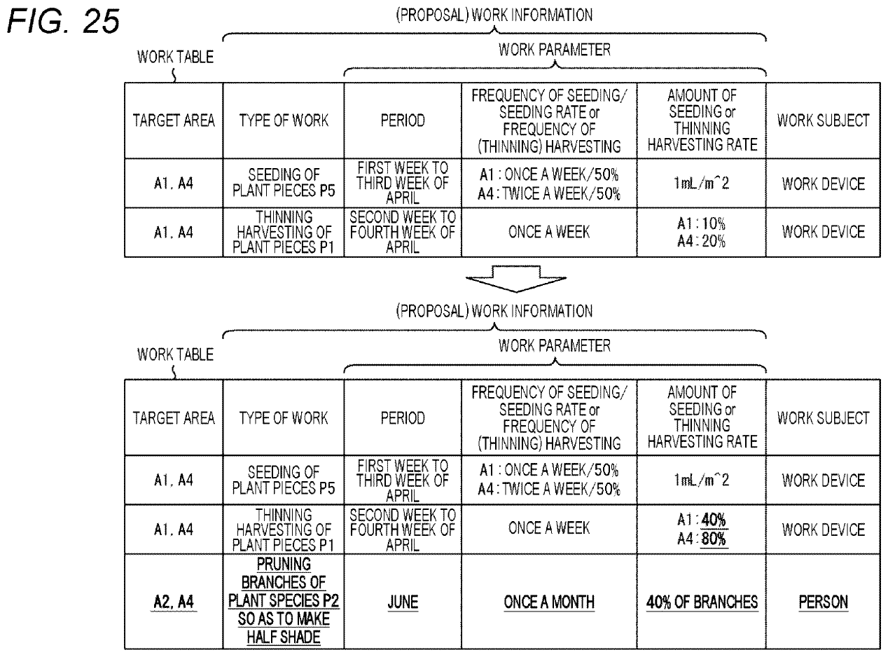

FIG. 25 is a view for explaining an example where the work table is edited.

In FIG. 25, the thinning harvesting rate as a work parameter included in the proposal work information of the thinning harvesting of the plant species P1 is edited to be corrected from 10% to 40% for the sub-area A1 and from 20% to 80% for the sub-area A4.

Furthermore, in FIG. 25, editing is performed to add a work of pruning (thinning harvesting) branches of the plant species P2 so as to make half shade. For the work of pruning the plant species P2, a period is set at June, a frequency is set at once a month, and a thinning harvesting rate is set at 40% of the branches. Regarding the work of pruning the branches of the plant species P2 so as to make half shade in the target area, there is no work device 22 capable of such a work, and thus, a person is the work subject.

By the way, in the presentation UI of FIG. 24, for example, a vegetation image of the current target ecosystem and a work table including the proposal work information indicating the work to be performed on the current target ecosystem are presented. However, the time-series change of the target ecosystem in a case where the work indicated by the proposal work information is performed on the target ecosystem is not presented.

Thus, in a case where the work indicated by the proposal work information is performed on the target ecosystem, it is necessary for the user to imagine how the target ecosystem changes. It can be therefore said that the presentation UI in FIG. 24 is a UI for a user (advanced-level person) (user with knowledge) who is skilled to some extent and can imagine how the target ecosystem changes.

For example, in the presentation UI of FIG. 24, the work of thinning harvesting of the plant species P1 is performed at a thinning harvesting rate of 10% in the sub-area A1. According to this work of thinning harvesting, in the sub-area A1, the coverage of the plant species P1 decreases by 10% every time the work of thinning harvesting is performed.

On the other hand, the plant species P1 grow and the coverage of the plant species P1 recovers (increases) by the amount corresponding to the growth during the period from the work of thinning harvesting to the subsequent work of thinning harvesting. A degree of progress of the growth of the plant varies depending on the season, or the like, for example, and the skilled user can estimate the degree of progress of the growth of the plant varying depending on the season, or the like, to some extent.

Thus, the skilled user can estimate the time-series change in the state of the coverage of the plant species P1 in the ecosystem of the sub-area A1 to some extent from the work of thinning harvesting of the plant species P1 at the thinning harvesting rate of 10% performed in the sub-area A1 and the estimation result of the degree of progress of the growth of the plant.

On the other hand, it is difficult for a beginner user (user having no knowledge) to estimate the time-series change in the state such as the coverage of the ecosystem.

It is therefore convenient if there is a UI that allows a beginner user to recognize the time-series change of the ecosystem.

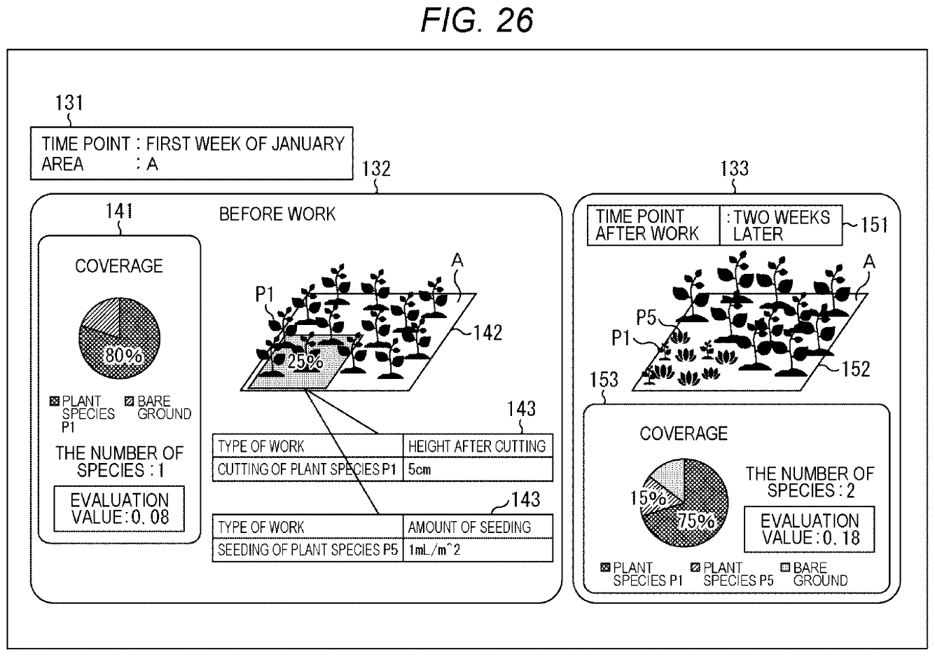

FIG. 26 is a view illustrating a second display example of the presentation UI.

In the presentation UI of FIG. 26, even a beginner user can recognize the time-series change of the ecosystem, for example, the state of the ecosystem before the work and the state of the ecosystem after the work.

The presentation UI of FIG. 26 includes regions 131, 132, and 133, and presents the regions 131 to 133.

In the region 131, a field of a time point and a field of an area are displayed.

In the field of the time point, a time point before the work is displayed. By default, for example, a current time point is displayed. The time point before the work displayed in the field of the time point can be set, for example, by the user operating the terminal 11. In FIG. 26, the first week of January is set as the time point before the work.

In the field of the area, information for specifying an area for which a vegetation image is displayed is displayed. The area in which the vegetation image is displayed can be set, for example, by the user operating the terminal 11. An area set as the area for which the vegetation image is displayed is also referred to as a set area. In FIG. 26, the area A is the set area.

In the region 132, a region 141, a vegetation image 142, and work information 143 are displayed.

In the region 141, the evaluation value calculated by the evaluation unit 84 of the state of the ecosystem of the set area at the time point before the work and items of the state of the ecosystem contributing to the evaluation value are displayed.

In FIG. 26, the evaluation value is calculated, for example, according to the formula [evaluation value]=[coverage by all plant species]×[degree of achievement to the target number of species (such as 10 species) (=[the number of plant species that are growing]/10 species) ].

Thus, the coverage of the set area by all plant species and the number of plant species that are growing in the set area are displayed as the items of the state of the ecosystem contributing to the evaluation value. The coverage is displayed as a circular graph in which an area of the area A, which is the set area, is 100%.

In FIG. 26, at the time point before the work, only one plant species P1 grows over the entire area A, and the plant species P1 covers 80% of the area of the area A.

Thus, the evaluation value is 0.80×1 species/10 species=0.08.

The vegetation image 142 is a vegetation image of the ecosystem of the area A which is the set area before the work.

In a case where the time point before the work is the current time point or the past time point, the vegetation image 142 is generated using the state information indicating the state of the ecosystem of the set area at the current time point or the past time point among the acquired state information. In a case where the time point before the work is a future time point, the vegetation image 142 is generated using, for example, prediction state information indicating the prediction state with the highest evaluation value of the prediction state of the ecosystem of the set area predicted using the state information.

As described above, in FIG. 26, only the plant species P1 covers 80% of the area A before the work, and thus, the vegetation image 142 is an image representing the area A in a state where the area is covered with the plant species P1 as described above.

The work information 143 is work information indicating the work to be performed (performed) in the area A which is the set area before the work.

In a case where the time point before the work is the past time point, the work information 143 is the executed work information performed at the past time point. In a case where the time point before the work is the current time point or the future time point, the work information 143 is, for example, the proposal work information determined according to the evaluation value, or the like, of the prediction state of the ecosystem of the set area predicted using the state information.

In FIG. 26, the work information indicating performing cutting (thinning harvesting) of the plant species P1 so that the height after cutting is set to 5 cm as a work parameter and work information indicating performing seeding of the plant species P5 with an amount of seeding of 1 mL/m\hat{ }2 as a work parameter are displayed as the work information 143.

The work information 143 is assigned to a sub-area having an area of 25% at the lower left corner of the area A which is the set area. In the vegetation image 142, the area corresponding to the sub-area to which the work information 143 is assigned is displayed in a display method different from that of the other areas, for example, in a different color. As a result, the user can easily recognize the sub-area to which the work information 143 is assigned.

The work information 143 is connected by a link (line) to a region of the vegetation image 142 corresponding to the sub-area to which the work information 143 is assigned. This makes it possible for the user to easily recognize the work information 143 assigned to the sub-area.

In a case where the work information 143 is the proposal work information, as described with reference to FIG. 22, the user can edit the work information 143 that is the proposal work information.

According to the work information 143, the user can confirm the work to be performed (performed) in the set area at the time point before the work.

In the region 133, a region 151, a vegetation image 152, and a region 153 are displayed.

In the region 151, a field of the time point after the work is displayed.

In the field of the time point after the work, the time point after the work in a case where the work indicated by the work information 143 is performed in the area A which is the set area at the time point before the work is displayed. As the time point after the work, for example, the user can set a time point later than the time point before the work by operating the terminal 11. In FIG. 26, an elapsed period from the time point before the work can be set as the time point after the work, and two weeks are set.

The vegetation image 152 is a vegetation image of the ecosystem of the area A at the time point after the work in a case where the work indicated by the work information 143 is performed in the area A which is the set area at the time point before the work.

In a case where the time point after the work is the current time point or the past time point, the vegetation image 152 is generated using the state information indicating the state of the ecosystem of the set area at the current time point or the past time point among the acquired state information. In a case where the time point after the work is a future time point, the vegetation image 152 is generated using, for example, prediction state information indicating the prediction state with the highest evaluation value of the prediction state of the ecosystem of the set area predicted using the state information.

Thus, as illustrated in FIG. 26, in a case where the time point before the work is the current time point and the time point after the work is two weeks after the current time point which is the time point before the work, the vegetation image 152 is the vegetation image of the ecosystem in the prediction state obtained by predicting the state of the ecosystem in the area A after two weeks from the work when the work indicated by the work information 143 is performed in the area A which is the set area.

In the work indicated by the work information 143, cutting of the plant species P1 is performed in a sub-area having an area of 25% at the lower left corner of the area A. Thus, in a region of the vegetation image 152 corresponding to a sub-area of 25% of the lower left corner of the area A, the plant species image of the plant species P1 is displayed smaller than that of the vegetation image 142 at the time point before the work.

Further, in the work indicated by the work information 143, the plant species P5 are seeded in a sub-area having an area of 25% in the lower left corner of the area A, and then the plant species P5 germinate by the time point after the work. Thus, in a region of the vegetation image 152 corresponding to a sub-area having an area of 25% at the lower left corner of the area A, a plant species image of the plant species P5 that is not present in the vegetation image 142 at the time before the work is displayed.

In addition, the plant species P1 growing in an area other than the sub-area having an area of 25% of the lower left corner of the area A grows between the time point before the work and the time point after the work. Thus, in a region of the vegetation image 152 corresponding to an area other than the sub-area of 25% of the lower left corner of the area A, the plant species image of the plant species P1 is displayed larger than that in the vegetation image 142 at the time point before the work.

In the region 153, the evaluation value of the state of the ecosystem of the set area calculated by the evaluation unit 84 at the time point after the work and items of the state of the ecosystem contributing to the evaluation value are displayed.

In the region 153, similarly to the region 141, the coverage of the set area by all plant species and the number of plant species growing in the set area are displayed as the items of the state of the ecosystem contributing to the evaluation value, and the coverage is displayed as a circular graph.

In FIG. 26, cutting of the plant species P1 indicated by the work information 143 is performed in a sub-area having an area of 25% of the lower left corner of the area A as the set area, whereby the coverage of the plant species P1 decreases. Furthermore, as a result of the plant species P1 in an area other than the sub-area growing, the coverage of the plant species P1 increases. As a result, the coverage of the plant species P1 decreases from 80% to 75% at the time point before the work.

In addition, in FIG. 26, seeding of the plant species P5 indicated by the work information 143 is performed in a sub-area having an area of 25% of the lower left corner of the area A, and the plant species P5 germinate, so that the coverage of the plant species P5 not present at the time point before the work increases. As a result, the coverage of the plant species P5 increases to 15% (from 0% at the time point before the work).

As described above, at the time point after the work, the two plant species P1 and P5 grow in the area A, the plant species P1 covers 75% of the area of the area A, and the plant species P5 covers 15% of the area A. Thus, the evaluation value is (0.75+0.15)×2 species/10 species=0.18, which is higher than the evaluation value 0.08 at the time point before the work.

According to the presentation UI of FIG. 26, the user can intuitively recognize which item of the state of the ecosystem contributes to the variation (such as improvement) of the evaluation value by referring to the evaluation value, the circular graph of the coverage, and the number of species. In other words, in FIG. 26, it is possible to intuitively recognize and learn that increase in the coverage and the number of species contribute to improvement of the evaluation value.

By referring to the work information 143 and the vegetation images 142 and 152, the user can easily recognize the change in the state of the ecosystem by the work to be performed (performed) on the ecosystem of the set area, particularly, the change in the vegetation.

By referring to the evaluation value and the work information 143, the user can intuitively recognize a relationship between the evaluation value and the work, that is, the work that improves the evaluation value.

Furthermore, the user can intuitively recognize and learn that the reason why the work indicated by the work information 143 is proposed is to improve the evaluation value (or to increase the coverage and the number of species).

Furthermore, by referring to the evaluation value and the vegetation images 142 and 152, the user can intuitively recognize and learn a relationship between the evaluation value and the change in vegetation, that is, how the vegetation changes to improve the evaluation value.

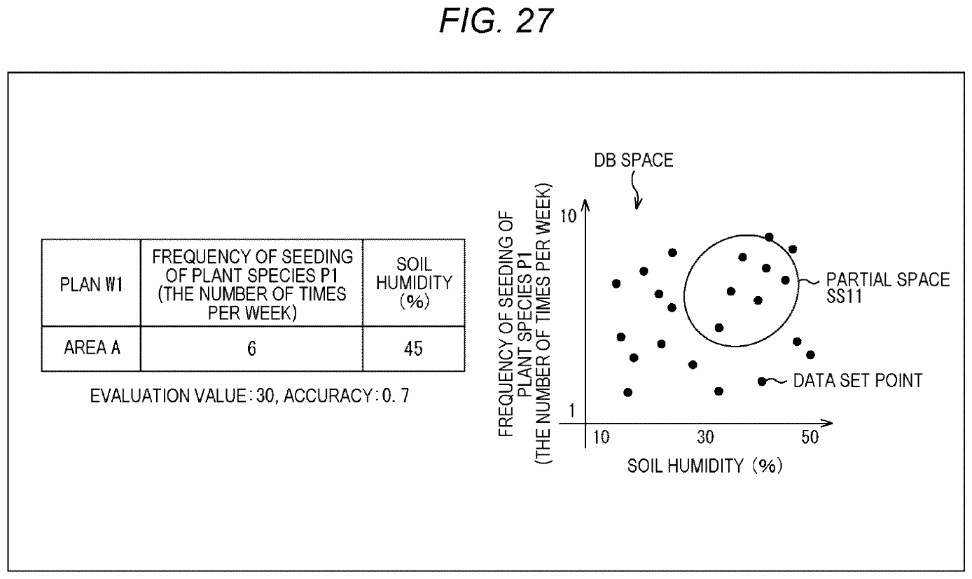

FIG. 27 is a view illustrating a third display example of the presentation UI.

FIG. 27 illustrates an example of the presentation UI that presents a plan and a DB space in which axes of the work information and the state information in the plan are set as a work axis and a pre-work state axis, respectively.

In FIG. 27, as the work information and the state information in the plan W1 , seeding of the plant species Pl in which a frequency of seeding is set as the work parameter, and the soil humidity are respectively adopted.

Thus, the work axis and the pre-work state axis are the frequency of seeding of the plant species P1 and the soil humidity, respectively. The seeding of the plant species P1 and the soil humidity respectively as the work information and the state information in the plan W1 are the proposal work information and the pre-work state information, respectively.

In the presentation UI of FIG. 27, in addition to the plan W1 and the DB space in which the frequency of seeding of the plant species P1 and the soil humidity in the plan W1 are set as the work axis and the pre-work state axis, respectively, the evaluation value and the prediction accuracy for the plan W1 are also presented.

The evaluation value and the prediction accuracy for the plan are the evaluation value and the prediction accuracy of the prediction state of the post-work ecosystem in a case where the work indicated by the work information in the plan is performed on the ecosystem of the state indicated by the state information in the plan.

In FIG. 27, the evaluation value and the prediction accuracy for the plan W1 are the evaluation value and the prediction accuracy of the prediction state of the ecosystem after the work in a case where the plant species P1 are seeded in the area A of the ecosystem having a soil humidity of 45% at a frequency of six times a week, and are 30 and 0.7, respectively.

In the presentation UI, the evaluation value and the prediction accuracy for the plan are presented and visualized, so that the user can refer to the evaluation value and the prediction accuracy for the plan.

By referring to the evaluation value for the plan, the user can predict the degree to which (the state of) the post-work ecosystem in a case where the work indicated by (proposal) work information in the plan is performed approaches (the state of) the target ecosystem, for example. Furthermore, by referring to the prediction accuracy for the plan, the user can recognize the prediction accuracy of the state (prediction state) of the post-work ecosystem in a case where the work indicated by the work information in the plan is performed, and eventually, the accuracy of the evaluation value of the state of the post-work ecosystem.

In the DB space in which the frequency of seeding of the plant species P1 and the soil humidity are respectively set as the work axis and the pre-work state axis, in a partial space SS11 centered around the data set point at which the frequency of seeding of the plant species P1 is (six times a week) and the soil humidity is (45%) in the plan W1 , the distribution of the data set points is dense, and the coverage is high.

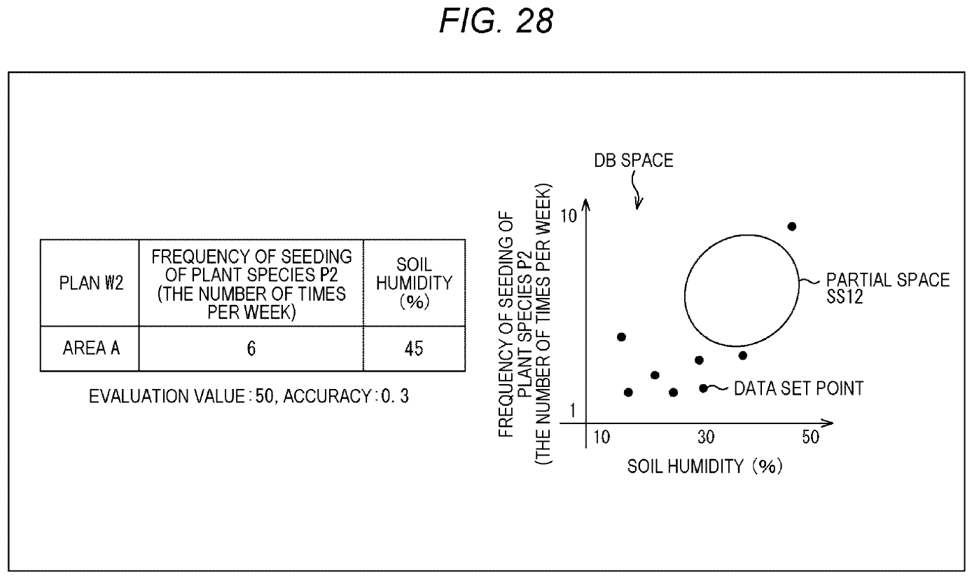

FIG. 28 is a view illustrating a fourth display example of the presentation UI.

FIG. 28 illustrates another example of the presentation UI that presents a plan and a DB space in which axes of the work information and the state information in the plan are set as the work axis and the pre-work state axis, respectively.

In FIG. 28, as the work information and the state information in the plan W2 , seeding of the plant species P2 having the frequency of seeding as the work parameter and the soil humidity are respectively adopted. Thus, the work axis and the pre-work state axis are axes of the frequency of seeding of the plant species P2 and the soil humidity, respectively. As in the case of FIG. 27, seeding of the plant species P2 and the soil humidity respectively as the work information and the state information in the plan W2 are the proposal work information and the pre-work state information, respectively.

In the presentation UI of FIG. 28, in a similar manner to the case of FIG. 27, in addition to the plan W2 and the DB space in which the frequency of seeding and the soil humidity of the plant species P2 in the plan W2 are respectively set as the work axis and the pre-work state axis, the evaluation value and the prediction accuracy for the plan W2 are also presented.

In FIG. 28, the evaluation value and the prediction accuracy for the plan W2 are the evaluation value and the prediction accuracy of the prediction state of the ecosystem after the work in a case where the plant species P2 are seeded at a frequency of six times a week in the area A of the ecosystem having a soil humidity of 45%, and are 50 and 0.3, respectively. Thus, the evaluation value in the plan W2 is higher than the evaluation value in the plan W1 in FIG. 27, but the prediction accuracy in the plan W2 is lower than the prediction accuracy in the plan W1 .

In the DB space in which the frequency of seeding of the plant species P2 and the soil humidity are set as the work axis and the pre-work state axis, respectively, in a partial space SS12 centered around the data set point at which the frequency of seeding is (six times a week) of the plant species P2 and the soil humidity is (45%) in the plan W2 , the distribution of the data set points is coarse, and the coverage is low.

Thus, according to the presentation UI in FIGS. 27 and 28, by referring to the distribution of the data set points in the DB space, the user can estimate and learn the relationship between the prediction accuracy and the distribution (coverage) of the data set points in the DB space and a factor that causes the prediction accuracy to be a value to be presented in the presentation UI.

For example, the user can estimate that the relationship between the prediction accuracy and the distribution of the data set points in the DB space is a relationship in which the prediction accuracy becomes higher as the distribution of the data set points is denser, and the prediction accuracy becomes lower as the distribution of the data set points is coarser. Then, the user can estimate that the factor that makes the prediction accuracy for the plan W1 in FIG. 27 a high value of 0.7 is that the distribution of the data set points is dense.

Furthermore, the user can estimate that the factor that makes the prediction accuracy for the plan W2 in FIG. 28 a low value of 0.3 is that the distribution of the data set points is coarse.

Note that, in FIGS. 27 and 28, the distribution itself of the data set points in the DB space is presented, but other information regarding the distribution of the data set points in the DB space, for example, the coverage can be presented.

Furthermore, in FIGS. 27 and 28, the distribution of the data set points in a two-dimensional space (plane) defined by the work axis and the pre-work state axis is presented for the DB space, but other presentation is also possible. For example, regarding the DB space, it is possible to present the distribution of data set points in a three-dimensional space (DB space) defined by the work axis, the pre-work state axis, and the post-work state axis.

### Relationship between the Number of Arranged Work Devices 22 and Work Parameters that can be Set

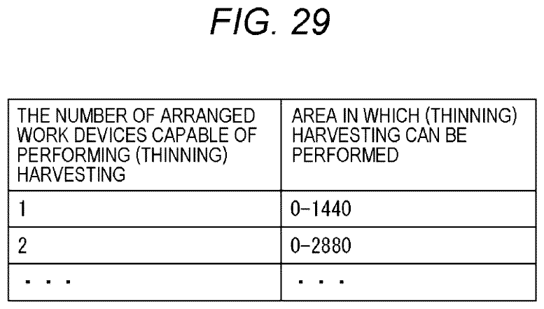

FIG. 29 is a view for explaining a relationship between the number of arranged work devices 22 and work parameters that can be set in generation of the candidate work information.

In the agricultural field, there is a case where only one work device 22 is arranged or a case where a plurality of work devices 22 is arranged depending on a scale of the agricultural field, or the like.

For the work devices 22 arranged in the agricultural field, an amount of the work that can be performed varies depending on the number of the work devices 22 arranged in the target area or the sub-area. In other words, for example, the amount of the work that can be performed is different between a case where only one work device is arranged in the target area or the sub-area and a case where a plurality of work devices 22 is arranged in the target area or the sub-area. Here, as illustrated in FIG. 6, in a case where the work device 22 operates by solar sharing, for example, a region of the agricultural field corresponding to one solar panel 53 can be set as the sub-area.

In order to simplify the explanation, as the work device 22, for example, only a work device capable of performing thinning harvesting on an area equal to or less than 1440 per day is considered.

In this case, in a case where one or more N work devices 22 are arranged, it is possible to perform thinning harvesting on an area equal to or less than 1440×N per day.

Thus, as illustrated in FIG. 29, a range of work parameters that can be set can be changed according to the number of arranged work devices 22.

For example, in a case where only one work device 22 is arranged, the work parameter can be set such that thinning harvesting is performed on any area in a range of 0 to 1440 per day. For example, in a case where two work devices 22 are arranged, the work parameter can be set such that thinning harvesting is performed on any area in the range of 0 to 2880 per day.

### Determination of Extension Work Information

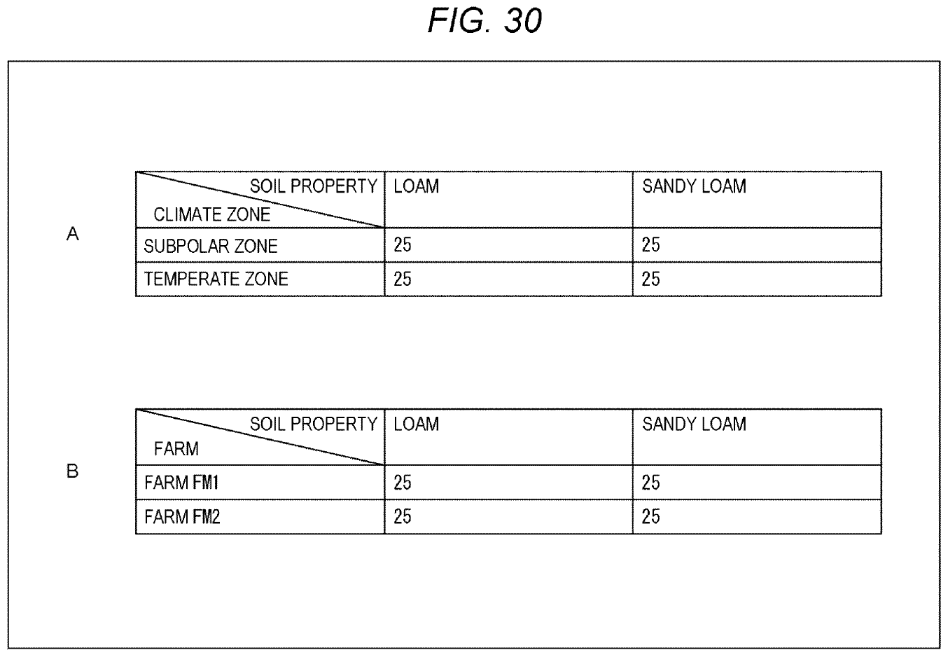

FIG. 30 is a view for explaining an example of determination of extension work information in a case where a range of the work that can be performed by the entire work devices 22 partially overlaps in a plurality of different areas.

Note that in FIG. 30, in order to simplify the explanation, the evaluation improvement work information is not considered.

In a case where a range of the work that can be performed by the entire work devices 22 in each area partially overlaps in a plurality of different areas, the extension work determination unit 102 (another determination unit) can determine the extension work information so that the same work is performed in at least part of each of the plurality of areas.

In this case, the same work is performed in the plurality of areas, so that it is possible to acquire the data set including the post-work state information indicating the state of the post-work ecosystem in a case where the same work is performed on the ecosystem of each of the plurality of areas. Further, the extension work information indicating the same work is determined for the plurality of areas, so that the processing load can be reduced as compared with a case where the extension work information is determined for each area.

In the plurality of areas, a state such as a position, a size (scale), biological diversity, and an environment of the ecosystem is different. Thus, by determining the extension work information so that the same work is performed on at least part of each of the plurality of areas, it is possible to collect data sets including the post-work state information in a case where the same work is performed on the ecosystems in different states, and to extend the DB 13.

According to the data sets in a case where the same work is performed on the ecosystems in different states, it is possible to improve the prediction accuracy of the state of the post-work ecosystem in a case where the work is performed at an early stage as compared with a case where the data sets are randomly collected.

Note that, from the viewpoint of extension of the DB 13, it is appropriate that the states of the ecosystems in the plurality of areas are different to some extent. It is therefore desirable that the plurality of areas is geographically separated to some extent, or climate zones are different, for example, as in Shizuoka and Kanagawa.

A of FIG. 30 illustrates an example of a plurality of areas for which the same extension work information is determined.

In A of FIG. 30, first, a plurality of areas in the subpolar zone and a plurality of areas in the temperate zone are selected according to the climate zone. Then, from the plurality of areas in the subpolar zone, 25 areas in which soil property is loam and 25 areas in which soil property is sandy loam are selected. Furthermore, in a similar manner, 25 areas in which soil property is loam and 25 areas in which soil property is sandy loam are selected from a plurality of areas in the temperate zone. The same extension work information is determined for the total of 100 areas selected as described above.

In this case, it is possible to acquire a data set including a state of the ecosystem after the work in a case where the same work is performed on the ecosystem in a state in which at least the climate zone and the soil property are different.

Here, in A of FIG. 30, it can be understood that first, a plurality of areas for which the same extension work information is determined is classified under an environmental condition of the climate zone, and thereafter, areas in each climate zone are classified under an environmental condition of the soil property. In this case, it can be said that the environmental condition of the climate zone is an environmental condition of a large scale, and the environmental condition of the soil property is an environmental condition of a small scale.

B of FIG. 30 illustrates another example of a plurality of areas in which the same extension work information is determined.

In B of FIG. 30, two farms FM1 and FM2 having at least an agricultural field having soil property of loam and an agricultural field having soil property of sandy loam are selected. Then, the area of the agricultural field having the loam of the farm FM1 is divided into 25 sub-areas, and the area of the farm field having the sandy loam is divided into 25 sub-areas. Furthermore, in the farm FM2, in a similar manner, the area of the agricultural field having the loam of the farm FM2 is divided into 25 sub-areas, and the area of the agricultural field having the sandy loam is divided into 25 sub-areas. The same extension work information is determined and assigned to a total of 100 sub-areas in the area of the agricultural field having the loam and the area of the agricultural field having the sandy loam of each of the farms FM1 and FM2 divided as described above.

In this case, it is possible to acquire data sets including state information indicating states of ecosystems after the work in a case where the same work is performed on the ecosystems in which at least soil property is different and other environmental conditions are further different between the farms FM1 and FM2.

In B of FIG. 30, it can be comprehensively said that various environmental conditions of the farm are environmental conditions with a large scale, and an environmental condition of soil property among various environmental conditions of the farm is an environmental condition with a small scale.

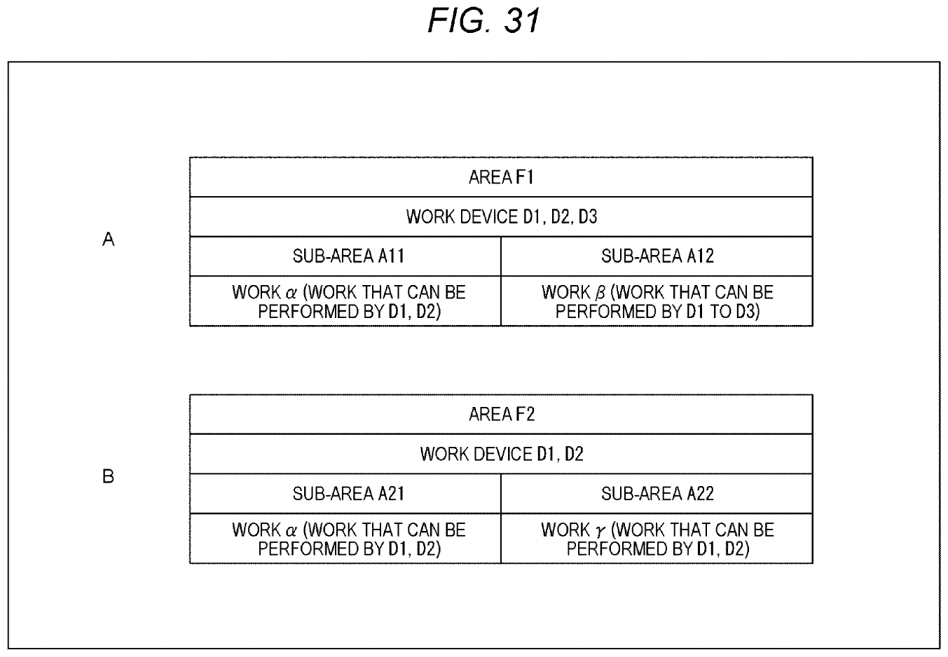

FIG. 31 is a view for explaining another example of determination of the extension work information in a case where a range of the work that can be performed by the entire work devices 22 partially overlaps in a plurality of different areas.

Note that in FIG. 31, in a similar manner to FIG. 30, the evaluation improvement work information is not considered in order to simplify the explanation.

A of FIG. 31 indicates an example of the work devices arranged in the area F1, the sub-areas obtained by dividing the area F1, and the extension work information (work represented by) assigned to the sub-areas.

B of FIG. 31 indicates an example of the work devices arranged in the area F2 different from the area F1, the sub-areas obtained by dividing the area F2, and the extension work information assigned to the sub-areas.

In FIG. 31, the work devices D1, D2, and D3 are arranged in the area F1, and the work devices D1 and D2 that are not the same as the work devices (are different from the work devices) in the case of the area F1 are arranged in the area F2.

The work devices D1 to D3 arranged in the area F1 are movable in the entire area Fl and can perform the work in the area F1. In a similar manner, the work devices D1 and D2 arranged in the area F2 are movable in the entire area F2, and can perform the work in the area F2.

The work devices D1 to D3 can perform the work independently and can also independently set (adjust) work parameters.

The range of the work that can be performed by the entire work devices in the area F1 is the range of the work that can be performed by the work devices D1 to D3, and the range of the work that can be performed by the entire work devices in the area F2 is the range of the work that can be performed by the work devices D1 and D2. Thus, in the areas F1 and F2, the range of the work that can be performed by the work devices D1 and D2 is the range of the work in which the work that can be performed by the entire work devices overlaps (hereinafter, also referred to as a common work range), that is, the range of the work that can be performed in both the areas F1 and F2.

The area F1 is divided into a plurality of sub-areas, for example, two sub-areas A11 and A12. The area F2 is also divided into a plurality of sub-areas, for example, two sub-areas A21 and A22.

In determination of the extension work information, the work information indicating an arbitrary work & within the common work range of the areas F1 and F2 is determined as the extension work information, and is assigned to part of each of the areas F1 and F2, for example, the sub-areas A11 and A21.

For example, it is assumed that the work device D1 can perform seeding as a work in a range in which the amount of seeding as the work parameter is set at 0 to 10 mL/m\hat{ }2. In addition, it is assumed that the work device D2 can perform seeding as a work in a range in which the amount of seeding as the work parameter is set at 0 to 5 mL/m\hat{ }2. Further, it is assumed that the work device D3 can perform seeding as a work in a range in which the amount of seeding as the work parameter is set at 0 to 3 mL/m\hat{ }2.

In this case, the range of the work that can be performed by the entire work devices D1 to D3 in the area F1 is seeding in the range of 0 to 18 mL/m\hat{ }2, and the range of the work that can be performed by the entire work devices D1 and D2 in the area F2 is seeding in the range of 0 to 15 mL/m\hat{ }2. Thus, the common work range of the areas F1 and F2 is seeding in the range of 0 to 15 mL/m\hat{ }2.

In the determination of the extension work information, the work information indicating the work α which is seeding in an arbitrary predetermined amount among seeding in the range of 0 to 15 mL/m\hat{ }2 which is the common work range of the areas F1 and F2 is determined as the extension work information and assigned to the sub-areas A11 and A21. In this case, in the sub-area A11, the work devices D1 and D2 among the work devices D1 to D3 arranged in the area F1 operate, and the work & indicated by the extension work information is performed. In the sub-area A21, the work devices D1 and D2 arranged in the area F2 operate, and the work & indicated by the extension work information is performed.

In addition, in the determination of the extension work information, the work information indicating the work B, which is seeding in an arbitrary predetermined amount among the range of the work that can be performed by the entire work devices D1 to D3 in the area F1, for example, the range of 0 to 18 mL/m\hat{ }2, is determined as the extension work information. Then, the extension work information indicating the work β is assigned to another part of the area F1, for example, the sub-area A12. In this case, in the sub-area A12, the work devices D1 to D3 arranged in the area F1 operate, and the work & indicated by the extension work information is performed.

Further, in the determination of the extension work information, the work information indicating the work y, which is seeding in an arbitrary predetermined amount among the range of the work that can be performed by the entire work devices D1 and D2 in the area F2, for example, the range of 0 to 15 mL/m\hat{ }2, is determined as the extension work information. Then, the extension work information indicating the work y is assigned to another part of the area F2, for example, the sub-area A22. In this case, in the sub-area A22, the work devices D1 and D2 arranged in the area F2 operate, and the work y indicated by the extension work information is performed.

The works x and y are works that can be performed by the entire work devices D1 and D2, but respective pieces of extension work information indicating the works x and y are independently determined, and thus, the works may be different from each other, but the works may be the same.

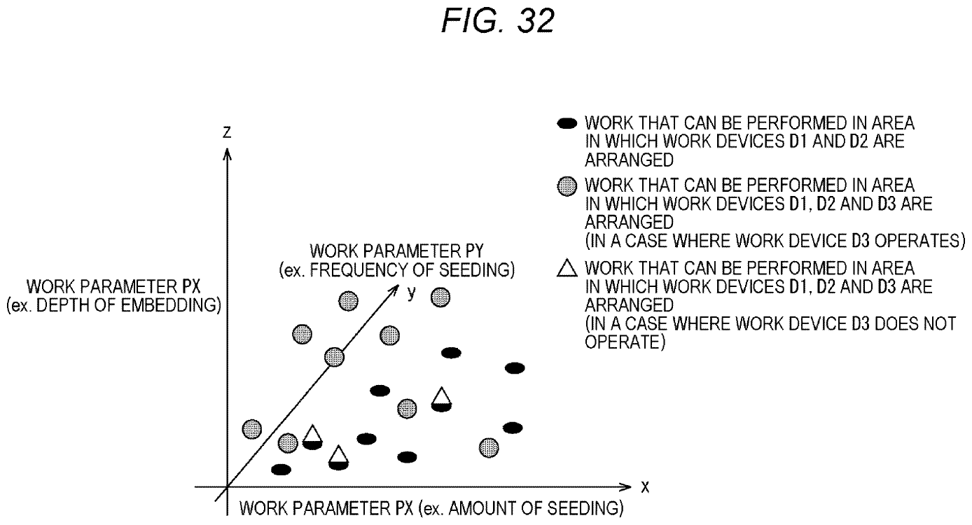

FIG. 32 is a view for further explaining another example of determination of the extension work information in a case where the range of the work that can be performed by the entire work devices 22 partially overlaps in a plurality of different areas.

For example, as described with reference to FIG. 31, it is assumed that the work devices D1 to D3 are arranged in the area F1, and the work devices D1 and D2 are arranged in the area F2.

For example, it is assumed that both the work devices D1 and D2 can perform the work of seeding, and for example, the amount and frequency of seeding can be set (adjusted) as the work parameters PX and PY. It is assumed that the work device D3 can perform, for example, an embedding work of pushing seeds seeded on the ground surface and embedding the seeds into the ground, and in the embedding work, for example, a depth of embedding can be set as the work parameter PZ.

FIG. 32 indicates a parameter space in which the work parameters PX, PY, and PZ are set at an x axis, a y axis, and a z axis, respectively.

In the drawing, a perfect circle, a triangle, and an ellipse represent points in the parameter space.

The points represented by the perfect circle and the triangle represent parameter sets of the work parameters PX, PY, and PZ of the work that can be performed in the area F1 in which the work devices D1 to D3 are arranged.

However, the point represented by the perfect circle represents a parameter set in a case where all of the work devices D1 to D3 operate. The point represented by the triangle represents a parameter set in a case where the work devices D1 and D2 operate and the work device D3 do not operate among the work devices D1 to D3. The point represented by the ellipse represents a parameter set of the work parameters PX and PY of the work that can be performed in the area F2 in which the work devices D1 and D2 are arranged.

The parameter set represented by the perfect circle (represented by a point) is a point in the parameter space, and the parameter set represented by each of the triangle and the ellipse is a point on the xy plane in the parameter space.

Determination of the extension work information representing the work a within the common work range of the areas F1 and F2 and determination of the extension work information representing the work y within the work range that can be performed by the entire work devices D1 and D2 in the area F2 correspond to determination of a parameter set represented by a point on the xy plane in the parameter space.

Determination of the extension work information representing the work & within the range of the work that can be performed by the entire work devices D1 to D3 in the area F1 corresponds to determination of a parameter set represented by a point in the parameter space.

Note that embodiments of the present technology are not limited to the above-described embodiments, and various changes can be made without departing from the gist of the present technology.

As an embodiment of the present technology, in addition to the above-described embodiments, in each embodiment, a mode in which components of other embodiments are combined and a mode in which part of the components is not provided can be employed as much as possible.

For example, the processing of restricting the candidate work information for which the prediction state is to be predicted according to the restriction information of FIG. 17 can be performed in the server 12 of FIGS. 20, 22, and 23. Furthermore, for example, in FIGS. 22 and 23, the server 12 can be configured without the prediction accuracy calculation unit 101 and the extension work determination unit 102 being provided.

The present technology may be configured as cloud computing in which one function is shared by a plurality of apparatuses through the network to process together.

Each step of the processing of the terminal 11 and the server 12 can be executed by one apparatus or can be shared and executed by a plurality of apparatuses.

In a case where a plurality of kinds of processing is included in one step, the plurality of kinds of processing included in the one step can be executed by one apparatus or can be shared and executed by a plurality of apparatuses.

Furthermore, the effects described in the present specification are merely examples and are not restrictive, and some other effects may be achieved.

Here, the present technology can relate to at least Goal 1 “No Poverty”, Goal 2 “Zero Hunger”, Goal 13 “Climate Action”, and Goal 15 “Life on Land” among the sustainable development goals (SDGs) adopted at the UN summit in 2015.

Synecoculture (registered trademark) used in the present technology enables cultivation of plants by controlling the ecosystem to promote biodiversity and further to be resilient to climate changes caused by natural disasters such as droughts and landslides.

Furthermore, it is possible to increase a fixed amount of greenhouse gases (GHGs) in order to generate a state where plants are mixed densely, and it is further possible to contribute to reducing greenhouse gas emissions without using fertilizers or pesticides.

Note that the present technology can be configured as follows.

### 1

An information processing apparatus including:
a prediction unit that predicts a state of an ecosystem after a work in a case where a work indicated by work information including a type of the work by a work device and a work parameter is performed on the ecosystem by using state information regarding a state of the ecosystem including biological diversity of the ecosystem;
an evaluation unit that evaluates a prediction state that is the predicted state of the ecosystem; and
a determination unit that determines proposal work information that is the work information to be proposed according to an evaluation result of the prediction state.

### 2

The information processing apparatus according to <1>, in which
the prediction unit predicts the prediction state using a data set that is a set of
pre-work state information that is the state information of the ecosystem before the work,
the work information indicating the work performed on the ecosystem in a state indicated by the pre-work state information, and
post-work state information indicating a state of the ecosystem after the work indicated by the work information is performed,
stored in a database (DB).

### 3

The information processing apparatus according to <2>, in which
the prediction unit predicts the prediction state by using a prediction model that has learned using the pre-work state information and the work information as inputs and the post-work state information as an output.

### 4

The information processing apparatus according to any one of <1> to <3>, in which
the prediction unit predicts the prediction state for each piece of candidate work information that is a plurality of pieces of work information representing a plurality of work candidates, and
the determination unit determines the proposal work information according to an evaluation result of the prediction state for each of the plurality of pieces of candidate work information.

### 5 >

The information processing apparatus according to <4>, in which
the prediction unit restricts the candidate work information for which the prediction state is to be predicted according to restriction information for restricting the candidate work information for which the prediction state is to be predicted.

### 6 >

The information processing apparatus according to <5>, in which
the restriction information is a vegetation strategy of the ecosystem.

### 7 >

The information processing apparatus according to any one of <1> to <6>, in which
the evaluation unit sets an evaluation method for evaluating the prediction state and evaluates the prediction state in accordance with the evaluation method.

### 8 >

The information processing apparatus according to any one of <1> to <7>, in which
the determination unit determines, as the proposal work information, peripheral work information that is the work information having, as a work parameter, a peripheral value of the work parameter of the work information with high evaluation of the prediction state.

### 9 >

The information processing apparatus according to any one of <1> to <8>, in which
the determination unit determines the proposal work information in accordance with prediction accuracy of the prediction state.

### 10 >

The information processing apparatus according to any one of <1> to <8>, in which
the determination unit edits the proposal work information in accordance with information from a user.

### 11 >

The information processing apparatus according to <10>, in which
the determination unit edits the proposal work information in accordance with information from a plurality of users.

### 12 >

The information processing apparatus according to any one of <1> to <11>, in which
the determination unit performs assignment of the proposal work information of assigning the proposal work information to an area in which the work indicated by the proposal work information is to be performed, and
in the assignment of the proposal work information, the proposal work information is assigned to an area having a size according to an evaluation result of the prediction state in a case where the work indicated by the proposal work information is performed.

### 13 >

The information processing apparatus according to any one of <1> to <12>, further including:
a generation unit that generates a presentation user interface (UI) that presents the proposal work information.

### 14 >

The information processing apparatus according to <13>, in which
the generation unit generates the presentation UI that presents a vegetation image including vegetation of the ecosystem on which the work indicated by the proposal work information is to be performed.

### 15 >

The information processing apparatus according to <13>or <14>, in which
the evaluation unit calculates an evaluation value of the prediction state, and
the generation unit generates the presentation UI that presents the evaluation value and an item of the state of the ecosystem that contributes to the evaluation value.

### 16 >

The information processing apparatus according to any one of <13> to <15>, in which
the prediction unit predicts the prediction state using a data set that is a set of
pre-work state information that is the state information of the ecosystem before the work,
the work information indicating the work performed on the ecosystem in a state indicated by the pre-work state information, and
post-work state information indicating a state of the ecosystem after the work indicated by the work information is performed,
stored in a database (DB), and
the generation unit generates the presentation UI that presents information regarding a distribution of data set points indicating the data set in a DB space in which the pre-work state information, the work information, and the post-work state information are set as axes.

### 17 >

The information processing apparatus according to any one of <1> to <16>, in which
the prediction unit predicts the prediction state using a data set that is a set of
pre-work state information that is the state information of the ecosystem before the work,
the work information indicating the work performed on the ecosystem in a state indicated by the pre-work state information, and
post-work state information indicating the state of the ecosystem after the work indicated by the work information is performed,
stored in a database (DB), and
the determination unit determines, as the proposal work information, extension work information that is the work information for extending the DB that collects the data set to be stored in the DB.

### 18 >

The information processing apparatus according to <17>, further including:
another determination unit that determines the extension work information such that the same work is performed on at least part of each of a plurality of areas.

### 19 >

An information processing method including:
predicting a state of an ecosystem after a work in a case where a work indicated by work information including a type of the work by a work device and a work parameter is performed on the ecosystem by using state information regarding a state of the ecosystem including biological diversity of the ecosystem;
evaluating a prediction state that is the predicted state of the ecosystem; and
determining proposal work information that is the work information to be proposed according to an evaluation result of the prediction state.

### 20 >

A program for causing a computer to function as:
a prediction unit that predicts a state of an ecosystem after a work in a case where a work indicated by work information including a type of the work by a work device and a work parameter is performed on the ecosystem by using state information regarding a state of the ecosystem including biological diversity of the ecosystem;
an evaluation unit that evaluates a prediction state that is the predicted state of the ecosystem; and
a determination unit that determines proposal work information that is the work information to be proposed according to an evaluation result of the prediction state.

### REFERENCE SIGNS LIST

10 Information processing system
11-1 to 11-4 Terminal
12 Server
13 Database
14 Network
21 Sensor unit
22 Work device
31 Communication unit
32 Calculation unit
33 Input/output unit
34 Storage
35 Positioning unit
41 Communication unit
42 Calculation unit
43 Input/output unit
44 Storage
51 Pillar
52 Rail
53 Solar panel
54, 55 Robot
60 Watering device
61 Pillar
62 Pipe
63 Communication cable
64 Water pipe
65 Water spray nozzle
66 Nozzle opening and closing device
67 Nozzle
68 Nozzle control device 68
69 Water supply pump
70 Water tank
81 Information acquisition unit
82 Prediction model generation unit
83 Prediction unit
84 Evaluation unit
85 Work selection unit
86 Work determination unit
87 Generation unit
101 Prediction accuracy calculation unit
102 Extension work determination unit
110 External system
111 Generation unit
131 to 133, 141 Region
142 Vegetation image
143 Work information
151 Region
152 Vegetation image
153 Region

1. An information processing apparatus comprising:
a prediction unit that predicts a state of an ecosystem after a work in a case where a work indicated by work information including a type of the work by a work device and a work parameter is performed on the ecosystem by using state information regarding a state of the ecosystem including biological diversity of the ecosystem;
an evaluation unit that evaluates a prediction state that is the predicted state of the ecosystem; and
a determination unit that determines proposal work information that is the work information to be proposed according to an evaluation result of the prediction state.

2. The information processing apparatus according to claim 1, wherein
the prediction unit predicts the prediction state using a data set that is a set of
pre-work state information that is the state information of the ecosystem before the work,
the work information indicating the work performed on the ecosystem in a state indicated by the pre-work state information, and
post-work state information indicating a state of the ecosystem after the work indicated by the work information is performed,
stored in a database (DB).

3. The information processing apparatus according to claim 2, wherein
the prediction unit predicts the prediction state by using a prediction model that has learned using the pre-work state information and the work information as inputs and the post-work state information as an output.

4. The information processing apparatus according to claim 1, wherein
the prediction unit predicts the prediction state for each piece of candidate work information that is a plurality of pieces of work information representing a plurality of work candidates, and
the determination unit determines the proposal work information according to an evaluation result of the prediction state for each of the plurality of pieces of candidate work information.

5. The information processing apparatus according to claim 4, wherein
the prediction unit restricts the candidate work information for which the prediction state is to be predicted according to restriction information for restricting the candidate work information for which the prediction state is to be predicted.

6. The information processing apparatus according to claim 5, wherein
the restriction information is a vegetation strategy of the ecosystem.

7. The information processing apparatus according to claim 1, wherein
the evaluation unit sets an evaluation method for evaluating the prediction state and evaluates the prediction state in accordance with the evaluation method.

8. The information processing apparatus according to claim 1, wherein
the determination unit determines, as the proposal work information, peripheral work information that is the work information having, as a work parameter, a peripheral value of the work parameter of the work information with high evaluation of the prediction state.

9. The information processing apparatus according to claim 1, wherein
the determination unit determines the proposal work information in accordance with prediction accuracy of the prediction state.

10. The information processing apparatus according to claim 1, wherein
the determination unit edits the proposal work information in accordance with information from a user.

11. The information processing apparatus according to claim 10, wherein
the determination unit edits the proposal work information in accordance with information from a plurality of users.

12. The information processing apparatus according to claim 1, wherein
the determination unit performs assignment of the proposal work information of assigning the proposal work information to an area in which the work indicated by the proposal work information is to be performed, and
in the assignment of the proposal work information, the proposal work information is assigned to an area having a size according to an evaluation result of the prediction state in a case where the work indicated by the proposal work information is performed.

13. The information processing apparatus according to claim 1, further comprising:
a generation unit that generates a presentation user interface (UI) that presents the proposal work information.

14. The information processing apparatus according to claim 13, wherein
the generation unit generates the presentation UI that presents a vegetation image including vegetation of the ecosystem on which the work indicated by the proposal work information is to be performed.

15. The information processing apparatus according to claim 13, wherein
the evaluation unit calculates an evaluation value of the prediction state, and
the generation unit generates the presentation UI that presents the evaluation value and an item of the state of the ecosystem that contributes to the evaluation value.

16. The information processing apparatus according to claim 13, wherein
the prediction unit predicts the prediction state using a data set that is a set of
pre-work state information that is the state information of the ecosystem before the work,
the work information indicating work performed on the ecosystem in a state indicated by the pre-work state information, and
post-work state information indicating a state of the ecosystem after the work indicated by the work information is performed,
stored in a database (DB), and
the generation unit generates the presentation UI that presents information regarding a distribution of data set points indicating the data set in a DB space in which the pre-work state information, the work information, and the post-work state information are set as axes.

17. The information processing apparatus according to claim 1, wherein
the prediction unit predicts the prediction state using a data set that is a set of
pre-work state information that is the state information of the ecosystem before the work,
the work information indicating the work performed on the ecosystem in a state indicated by the pre-work state information, and
post-work state information indicating a state of the ecosystem after the work indicated by the work information is performed,
stored in a database (DB), and
the determination unit determines, as the proposal work information, extension work information that is the work information for extending the DB that collects the data set to be stored in the DB.

18. The information processing apparatus according to claim 17, further comprising:
another determination unit that determines the extension work information such that the same work is performed on at least part of each of a plurality of areas.

19. An information processing method comprising:
predicting a state of an ecosystem after a work in a case where a work indicated by work information including a type of the work by a work device and a work parameter is performed on the ecosystem by using state information regarding a state of the ecosystem including biological diversity of the ecosystem;
evaluating a prediction state that is the predicted state of the ecosystem; and
determining proposal work information that is the work information to be proposed according to an evaluation result of the prediction state.

20. A program for causing a computer to function as:
a prediction unit that predicts a state of an ecosystem after a work in a case where a work indicated by work information including a type of the work by a work device and a work parameter is performed on the ecosystem by using state information regarding a state of the ecosystem including biological diversity of the ecosystem;
an evaluation unit that evaluates a prediction state that is the predicted state of the ecosystem; and
a determination unit that determines proposal work information that is the work information to be proposed according to an evaluation result of the prediction state.
